(19) United States
(12) Patent Application Publication
(10) Pub. No.: US 2026/0095759 A1
(43) Pub. Date: Apr. 2, 2026

(54) NON-ACCESS STRATUM MESSAGE PROCESSING METHOD AND APPARATUS

(71) Applicant: HUAWEI TECHNOLOGIES CO., LTD., Shenzhen (CN)

(72) Inventors: Jun Wang, Shanghai (CN); Weijun Xing, Shanghai (CN); Yan Xi, Shanghai (CN); Wenhui Wang, Shanghai (CN); Chenghui Peng, Shanghai (CN); Shaoyun Wu, Shanghai (CN)

(73) Assignee: HUAWEI TECHNOLOGIES CO., LTD., Shenzhen (CN)

(21) Appl. No.: 19/411,749

(22) Filed: Dec. 8, 2025

Related U.S. Application Data
(63) Continuation of application No. PCT/CN2023/100304, filed on Jun. 14, 2023.

(51) Int. Cl. H04W 12/041

(52) U.S. Cl. CPC H04W 12/041

(57) ABSTRACT

A non-access stratum (NAS) message processing method and apparatus. The method includes: a terminal device generates a plurality of NAS keys, where at least two of the plurality of NAS keys are respectively associated with different NFs, and the plurality of NAS keys include a first NAS key for a first NF. The first NF generates a first NAS key, where the first NF is a non-anchor function. The terminal device processes a NAS message between the terminal device and the first NF based on the first NAS key generated by the terminal device. The first NF processes a NAS message between the first NF and the terminal device based on the first NAS key generated by the first NF.

### CROSS-REFERENCE TO RELATED APPLICATIONS

This is a continuation of International Patent Application No. PCT/CN2023/100304, filed on Jun. 14, 2023, the disclosure of which is hereby incorporated by reference in its entirety.

### TECHNICAL FIELD

The embodiments relate to the communication field, for example, to a non-access stratum message processing method and apparatus.

### BACKGROUND

In a 5th generation (5G) communication system, a base station is directly connected to (a “direct connection” for short) an access and mobility management function (AMF), and is not directly connected to another control plane core network function (CN NF). Therefore, a message between another control plane CN NF and the base station may be transmitted through the AMF. In other words, the AMF is an agent between the base station and another control plane CN NF. However, this architecture increases a transmission latency, and consequently is not friendly to a latency-sensitive service (for example, an ultra-reliable low-latency communication (URLLC) service).

A plurality of NFs may be directly connected to a base station in a future communication system, to reduce a transmission latency. On this basis, how to update a non-access stratum (NAS) security mechanism to adapt to a future communication system is an urgent problem to be resolved.

### SUMMARY

The embodiments provide a NAS message processing method and apparatus, to update a NAS security mechanism, so that the NAS security mechanism is applicable to a future communication system.

According to a first aspect, a NAS message processing method is provided, including:

A terminal device generates a plurality of non-access stratum (NAS) keys. At least two of the plurality of NAS keys are respectively associated with different network functions (NFs) in a plurality of NFs. The terminal device processes a NAS message for communication with the plurality of NFs based on the plurality of NAS keys.

According to this embodiment, after a radio access network device is directly connected to a plurality of CN NFs, the terminal device may generate a NAS key associated with each of the plurality of CN NFs, to process a received NAS message (for example, perform encryption/decryption and/or integrity protection).

With reference to the first aspect, in some embodiments of the first aspect, that the terminal device generates the plurality of NAS keys includes:

The terminal device generates a first NAS key based on one or more of a type parameter of a first NF, an identifier of the first NF, an identifier of a security algorithm selected by the first NF, a NAS count of the first NF, and a PDU session identifier. The first NF is one of the plurality of NFs, and the first NAS key is one of the plurality of NAS keys.

With reference to the first aspect, in some embodiments of the first aspect, that the terminal device generates the plurality of NAS keys includes:

The terminal device generates a first NAS key based on a type parameter of a first NF and/or an identifier of the first NF, an identifier of a security algorithm selected by the first NF, and a NAS count of the first NF. The first NF is one of the plurality of NFs, and the first NAS key is one of the plurality of NAS keys.

With reference to the first aspect, in some embodiments of the first aspect, that the terminal device generates the plurality of NAS keys includes:

The terminal device generates a first NAS key based on a type parameter of a first NF and/or an identifier of the first NF, an identifier of a security algorithm selected by the first NF, a NAS count of the first NF, and a PDU session identifier. The first NF is one of the plurality of NFs, and the first NAS key is one of the plurality of NAS keys.

With reference to the first aspect, in some embodiments of the first aspect, that terminal device generates the plurality of NAS keys includes:

The terminal device generates a first NAS key based on an identifier of a security algorithm selected by a first NF, a NAS count of the first NF, and a PDU session identifier. The first NF is one of the plurality of NFs, and the first NAS key is one of the plurality of NAS keys.

With reference to the first aspect, in some embodiments of the first aspect, the NAS count of the first NF starts from 0; or the NAS count of the first NF starts from an initial NAS count of an anchor function.

For example, the anchor function may be an AMF.

With reference to the first aspect, in some embodiments of the first aspect, that terminal device generates the plurality of NAS keys includes:

The terminal device generates the plurality of NAS keys based on a NAS root key.

For example, the NAS root key may be K_{SEAF}, K_{AMF}, a key (non-K_{AMF}) derived from K_{SEAF}, or a key derived from K_{AMF}.

With reference to the first aspect, in some embodiments of the first aspect, the method further includes:

The terminal device creates a NAS entity corresponding to the first NF. The first NF is one of the plurality of NFs.

With reference to the first aspect, in some embodiments of the first aspect, that the terminal device creates the NAS entity corresponding to the first NF includes:

The terminal device creates the NAS entity corresponding to the first NF after the terminal device accesses a core network for a first time and authentication succeeds; or the terminal device receives a message, and creates the NAS entity corresponding to the first NF based on the message.

With reference to the first aspect, in some embodiments of the first aspect, the method further includes:

The terminal device suspends the NAS entity corresponding to the first NF, and stores a security context of the first NF. The security context includes a type of the first NF and/or the identifier of the first NF, the NAS count of the first NF, and the identifier of the security algorithm selected by the first NF, and the first NF is one of the plurality of NFs.

With reference to the first aspect, in some embodiments of the first aspect, the security context further includes a PDU session identifier.

With reference to the first aspect, in some embodiments of the first aspect, the terminal device suspends the NAS entity corresponding to the first NF includes:

The terminal device suspends the NAS entity corresponding to the first NF when the terminal device enters an idle state or an inactive state; or the terminal device receives a message, and suspends the NAS entity corresponding to the first NF based on the message.

With reference to the first aspect, in some embodiments of the first aspect, the method further includes:

The terminal device deletes the NAS entity corresponding to the first NF, and deletes the security context of the first NF. The first NF is one of the plurality of NFs.

With reference to the first aspect, in some embodiments of the first aspect, that the terminal device deletes the NAS entity corresponding to the first NF includes:

The terminal device deletes the NAS entity corresponding to the first NF when the terminal device enters an idle state or an inactive state; or the terminal device receives a message, and deletes the NAS entity corresponding to the first NF based on the message.

With reference to the first aspect, in some embodiments of the first aspect, the method further includes:

The terminal device activates the first NAS key when creating the NAS entity corresponding to the first NF; or the terminal device receives a first message, and activates the first NAS key based on the first message. The first NF is one of the plurality of NFs, and the first NAS key is one of the plurality of NAS keys.

With reference to the first aspect, in some embodiments of the first aspect, the method further includes:

The terminal device deactivates the first NAS key when suspending or deleting the NAS entity corresponding to the first NF; or the terminal device receives a second message, and deactivates the first NAS key based on the second message. The first NF is one of the plurality of NFs, and the first NAS key is one of the plurality of NAS keys.

With reference to the first aspect, in some embodiments of the first aspect, the method further includes:

The terminal device stores a security context of the first NF when transitioning from a connected state to an idle state or an inactive state. The security context of the first NF includes the identifier of the security algorithm selected by the first NF and the NAS count of the first NF. The terminal device generates the first NAS key based on the security context of the first NF when transitioning from the idle state or the inactive state to the connected state. The first NF is one of the plurality of NFs, and the first NAS key is one of the plurality of NAS keys.

With reference to the first aspect, in some embodiments of the first aspect, the security context of the first NF further includes one or more of the type of the first NF, the identifier of the first NF, the PDU session identifier, and an identifier of the terminal device.

With reference to the first aspect, in some embodiments of the first aspect, the method further includes:

The terminal device does not store a security context of the first NF when transitioning from a connected state to an idle state or an inactive state; and when transitioning from the idle state or the inactive state to the connected state, the terminal device receives the security context of the first NF from a second NF, and generates the first NAS key based on the security context of the first NF. The second NF is configured to store the security context of the first NF. The first NF is one of the plurality of NFs, and the first NAS key is one of the plurality of NAS keys.

For example, the second NF may be the first NF. In other words, the first NF stores the security context. Alternatively, the second NF may be different from the first NF. In other words, the second NF replaces the first NF to store the security context. For example, the first NF is an SMF, and the second NF is an AMF. The SMF may send the security context to the AMF, and the AMF replaces the SMF to store the security context.

With reference to the first aspect, in some embodiments of the first aspect, the method further includes:

The terminal device does not store the NAS count of the first NF when transitioning from a connected state to an idle state or an inactive state; and the terminal device generates the first NAS key when transitioning from the idle state or the inactive state to the connected state. The NAS count corresponding to the first NF starts from 0, or the NAS count corresponding to the first NF starts from the initial NAS count of the anchor function; and the first NF is one of the plurality of NFs, and the first NAS key is one of the plurality of NAS keys.

With reference to the first aspect, in some embodiments of the first aspect, the method further includes:

The terminal device receives a third message from the first NF, and updates the first NAS key based on the third message, where the first NF is one of the plurality of NFs, and the first NAS key is one of the plurality of NAS keys; or the terminal device receives a fourth message from the anchor function, and updates the plurality of NAS keys based on the fourth message.

For example, the first NF may be any one of an AMF, an SMF, a PCF, and an LMF.

With reference to the first aspect, in some embodiments of the first aspect, when the terminal device is handed over from the first NF to a first target NF, the method further includes:

The terminal device receives the identifier of the security algorithm from the first target NF. The first NF is one of the plurality of NFs, and the first NF is a non-anchor function.

According to a second aspect, a NAS message processing method is provided, including:

A first network function NF generates a first non-access stratum (NAS) key; and the first NF processes a NAS message between the first NF and a terminal device based on the first NAS key. The first NF is a non-anchor function.

According to this embodiment, after a radio access network device is directly connected to a plurality of CN NFs, the first NF (a non-anchor function) in the plurality of CN NFs may generate a NAS key, to process a received NAS message (for example, perform encryption/decryption and/or integrity protection).

With reference to the second aspect, in some embodiments of the second aspect, that the first NF generates the first NAS key includes:

The first NF generates the first NAS key based on one or more of a type parameter of the first NF, an identifier of the first NF, an identifier of a security algorithm selected by the first NF or a NAS count maintained by the first NF, and a PDU session identifier.

With reference to the second aspect, in some embodiments of the second aspect, that the first NF generates the first NAS key includes:

The first NF generates the first NAS key based on a type parameter of the first NF and/or an identifier of the first NF, an identifier of a security algorithm selected by the first NF, and a NAS count maintained by the first NF.

With reference to the second aspect, in some embodiments of the second aspect, that the first NF generates the first NAS key includes:

The first NF generates the first NAS key based on a type parameter of the first NF and/or an identifier of the first NF, an identifier of a security algorithm selected by the first NF, a NAS count maintained by the first NF, and a PDU session identifier.

With reference to the second aspect, in some embodiments of the second aspect, that the first NF generates the first NAS key includes:

The first NF generates the first NAS key based on an identifier of a security algorithm selected by the first NF, a NAS count maintained by the first NF, and a PDU session identifier.

With reference to the second aspect, in some embodiments of the second aspect, the NAS count maintained by the first NF starts from 0, or the NAS count maintained by the first NF starts from an initial NAS count of an anchor function.

With reference to the second aspect, in some embodiments of the second aspect, that the first NF generates the first NAS key includes:

The first NF obtains a NAS root key from the anchor function; and the first NF generates the first NAS key based on the NAS root key.

For example, the NAS root key may be K_{SEAF}, K_{AMF}, a key (non-K_{AMF}) derived from K_{SEAF}, or a key derived from K_{AMF}.

With reference to the second aspect, in some embodiments of the second aspect, the method further includes:

The first NF creates a NAS entity corresponding to the first NF.

With reference to the second aspect, in some embodiments of the second aspect, that the first NF creates the NAS entity corresponding to the first NF includes:

The first NF creates the NAS entity corresponding to the first NF after successfully performing access authentication on the terminal device; or the first NF receives a message, and creates the NAS entity corresponding to the first NF based on the message.

With reference to the second aspect, in some embodiments of the second aspect, the method further includes:

The first NF suspends the NAS entity corresponding to the first NF, and stores a security context of the first NF. The security context includes the first NAS count, the identifier of the security algorithm selected by the first NF, and an identifier of the terminal device.

With reference to the second aspect, in some embodiments of the second aspect, the security context further includes one or more of a type of the first NF, the identifier of the first NF, and the PDU session identifier.

With reference to the second aspect, in some embodiments of the second aspect, that the first NF suspends the NAS entity corresponding to the first NF includes:

The first NF receives a message, and suspends the NAS entity corresponding to the first NF based on the message.

With reference to the second aspect, in some embodiments of the second aspect, the method further includes:

The first NF deletes the NAS entity corresponding to the first NF, and deletes the security context of the first NF.

With reference to the second aspect, in some embodiments of the second aspect, that the first NF deletes the NAS entity corresponding to the first NF includes:

The first NF receives a message, and deletes the NAS entity corresponding to the first NF based on the message.

With reference to the second aspect, in some embodiments of the second aspect, the method further includes:

The first NF activates the first NAS key when creating a NAS entity corresponding to the first NF; or the first NF receives a fifth message, and activates the first NAS key based on the fifth message.

With reference to the second aspect, in some embodiments of the second aspect, the method further includes:

The first NF receives activation success information, where the activation success information indicates that the terminal device successfully activates the first NAS key; and the first NF transmits the NAS message with the terminal device based on the activation success information.

With reference to the second aspect, in some embodiments of the second aspect, the method further includes:

The first NF deactivates the first NAS key when suspending or deleting the NAS entity corresponding to the first NF; or the first NF receives a sixth message, and deactivates the first NAS key based on the sixth message.

With reference to the second aspect, in some embodiments of the second aspect, the method further includes:

The first NF receives deactivation success information. The deactivation success information indicates that the terminal device successfully deactivates the first NAS key.

With reference to the second aspect, in some embodiments of the second aspect, the method further includes:

The first NF stores a security context of the terminal device when the terminal device transitions from a connected state to an idle state or an inactive state, where the security context of the terminal device includes the identifier of the security algorithm selected by the first NF, the NAS count of the first NF, and an identifier of the terminal device; and the first NF generates the first NAS key based on the security context of the terminal device when the terminal device transitions from the idle state or the inactive state to the connected state.

With reference to the second aspect, in some embodiments of the second aspect, the security context of the terminal device further includes one or more of a type of the first NF, the identifier of the first NF, and the PDU session identifier.

With reference to the second aspect, in some embodiments of the second aspect, the method further includes:

The first NF does not store a security context of the terminal device when the terminal device transitions from a connected state to an idle state or an inactive state; and when the terminal device transitions from the idle state or the inactive state to the connected state, the first NF obtains the security context of the terminal device from a second NF, and generates the first NAS key based on the security context of the terminal device.

With reference to the second aspect, in some embodiments of the second aspect, the method further includes:

The second NF stores a security context when the terminal device transitions from a connected state to an idle state or an inactive state, where the security context includes an identifier of the terminal device, a type of the first NF and/or an identifier of the first NF, the identifier of the security algorithm selected by the first NF, and the NAS count of the first NF; and the second NF sends the security context to the first NF and the terminal device when the terminal device transitions from the idle state or the inactive state to the connected state.

It may be understood that in this case, the second NF is different from the first NF. For example, the first NF is an SMF, an LMF, or a PCF, and the second NF is an AMF.

With reference to the second aspect, in some embodiments of the second aspect, the security context further includes a PDU session identifier.

With reference to the second aspect, in some embodiments of the second aspect, the method further includes:

The first NF does not store the NAS count of the first NF when the terminal device transitions from a connected state to an idle state or an inactive state; and the first NF generates the first NAS key when the terminal device transitions from the idle state or the inactive state to the connected state. The NAS count corresponding to the first NF starts from 0, or the NAS count corresponding to the first NF starts from the initial NAS count of the anchor function.

With reference to the second aspect, in some embodiments of the second aspect, the method further includes:

The first NF updates the first NAS key when a preset condition is met; and the first NF sends a third message, where the third message indicates the terminal device to update the first NAS key; or the first NF notifies the anchor function that the first NF successfully updates the first NAS key.

With reference to the second aspect, in some embodiments of the second aspect, the method further includes:

The anchor function receives a NAS key update request message from the first NF, where the plurality of NFs directly connected to the radio access network device include the first NF; the anchor function sends the NAS key update request message to an NF other than the first NF and the anchor function in the plurality of NFs directly connected to the radio access network device; the anchor function determines that each of the plurality of NFs directly connected to the radio access network device successfully updates a corresponding NAS key; and the anchor function sends a fourth message to the terminal device, where the fourth message indicates the terminal device to update NAS keys of the plurality of NFs directly connected to the radio access network device.

With reference to the second aspect, in some embodiments of the second aspect, the method further includes:

The first NF receives a message from the anchor function, and suspends NAS message transmission between the first NF and the terminal device during updating of the first NAS key based on the message.

With reference to the second aspect, in some embodiments of the second aspect, the method further includes:

The first NF receives a message from the anchor function, and resumes NAS message transmission between the first NF and the terminal device based on the message.

With reference to the second aspect, in some embodiments of the second aspect, when the terminal device is handed over from the first NF to a first target NF, the method further includes:

The first NF sends the security context of the terminal device to the first target NF. The security context of the terminal device includes the NAS count of the first NF.

With reference to the second aspect, in some embodiments of the second aspect, the security context of the terminal device further includes one or more of the following:
a PDU session identifier, and security capability information of the terminal device.

With reference to the second aspect, in some embodiments of the second aspect, that the first NF sends the security context of the terminal device to the first target NF includes:

The first NF directly sends the security context of the terminal device to the first target NF; or the first NF sends the security context of the terminal device to the first target NF through a source anchor function; or the first NF sends the security context of the terminal device to the first target NF through a source anchor function and a target anchor function.

With reference to the second aspect, in some embodiments of the second aspect, when the terminal device is handed over from the first NF to a first target NF, the method further includes:

The source anchor function sends security capability information of the terminal device to the first target NF.

With reference to the second aspect, in some embodiments of the second aspect, that the source anchor function sends the security capability information of the terminal device to the first target NF includes:

The source anchor function directly sends the security capability information of the terminal device to the first target NF; or
the source anchor function sends the security capability information of the terminal device to the first target NF through a target anchor function.

With reference to the second aspect, in some embodiments of the second aspect, when the terminal device is handed over from the first NF to a first target NF, the method further includes:

The source anchor function receives the identifier of the security algorithm selected by the first target NF; and the source anchor function sends, to the terminal device, the identifier of the security algorithm selected by the first target NF.

With reference to the second aspect, in some embodiments of the second aspect, that the source anchor function receives the identifier of the security algorithm selected by the first target NF includes:

The source anchor function receives, from the first target NF, the identifier of the security algorithm selected by the first target NF; or
the source anchor function receives, from the target anchor function, the identifier of the security algorithm selected by the first target NF.

According to a third aspect, a NAS message processing method is provided, including:

A terminal device generates a plurality of non-access stratum (NAS) keys. At least two of the plurality of NAS keys are respectively associated with different network functions (NFs) in a plurality of NFs, the plurality of NAS keys include a first NAS key for a first NF, and the first NF is one of the plurality of NFs. The first NF generates a first NAS key. The first NF is a non-anchor function. The terminal device processes a NAS message between the terminal device and the first NF based on the first NAS key generated by the terminal device. The first NF processes a NAS message between the first NF and the terminal device based on the first NAS key generated by the first NF.

In this embodiment, the first NAS key generated by the first NF may be the same as or different from the first NAS key generated by the terminal device for the first NF.

With reference to the third aspect, in some embodiments of the third aspect, the terminal device and the first NF generate the first NAS key based on one or more of a type parameter of the first NF, an identifier of the first NF, an identifier of a security algorithm selected by the first NF, a NAS count of the first NF, and a PDU session identifier. The plurality of NAS keys include the first NAS key.

With reference to the third aspect, in some embodiments of the third aspect, the terminal device and the first NF generate the first NAS key based on a type parameter of the first NF and/or an identifier of the first NF, an identifier of a security algorithm selected by the first NF, and a NAS count of the first NF.

With reference to the third aspect, in some embodiments of the third aspect, the terminal device and the first NF generate the first NAS key based on a type parameter of the first NF and/or an identifier of the first NF, an identifier of a security algorithm selected by the first NF, a NAS count of the first NF, and a PDU session identifier.

With reference to the third aspect, in some embodiments of the third aspect, the terminal device and the first NF generate the first NAS key based on an identifier of a security algorithm selected by the first NF, a NAS count of the first NF, and a PDU session identifier.

With reference to the third aspect, in some embodiments of the third aspect, the NAS count of the first NF starts from 0, or the NAS count of the first NF starts from an initial NAS count of an anchor function.

With reference to the third aspect, in some embodiments of the third aspect, the terminal device and the first NF generate the first NAS key based on a NAS root key.

With reference to the third aspect, in some embodiments of the third aspect, the method further includes:

The terminal device creates a NAS entity corresponding to the first NF; and the first NF creates a NAS entity corresponding to the first NF.

With reference to the third aspect, in some embodiments of the third aspect, the method further includes:

The terminal device suspends the NAS entity corresponding to the first NF; and the first NF suspends the NAS entity corresponding to the first NF.

With reference to the third aspect, in some embodiments of the third aspect, the method further includes:

The terminal device deletes the NAS entity corresponding to the first NF; and the first NF deletes the NAS entity corresponding to the first NF.

With reference to the third aspect, in some embodiments of the third aspect, the method further includes:

The terminal device activates the first NAS key generated by the terminal device; and the first NF activates the first NAS key generated by the first NF.

With reference to the third aspect, in some embodiments of the third aspect, the method further includes:

The terminal device sends activation success information, where the activation success information indicates that the terminal device successfully activates the first NAS key generated by the terminal device; the first NF receives the activation success information; and the first NF transmits a NAS message with the terminal device based on the activation success information.

With reference to the third aspect, in some embodiments of the third aspect, the method further includes:

The terminal device deactivates the first NAS key generated by the terminal device; and the first NF deactivates the first NAS key generated by the first NF.

With reference to the third aspect, in some embodiments of the third aspect, the method further includes:

The terminal device sends deactivation success information, where the deactivation success information indicates that the terminal device successfully deactivates the first NAS key generated by the terminal device; and the first NF receives the deactivation success information.

With reference to the third aspect, in some embodiments of the third aspect, the method further includes:

Both the first NF and the terminal device store a security context when the terminal device transitions from a connected state to an idle state or an inactive state; and the first NF and the terminal device each generate the first NAS key based on the stored security context when the terminal device transitions from the idle state or the inactive state to the connected state.

With reference to the third aspect, in some embodiments of the third aspect, the method further includes:

Neither the first NF nor the terminal device stores a security context when the terminal device transitions from a connected state to an idle state or an inactive state; and when the terminal device transitions from the idle state or the inactive state to the connected state, the first NF and the terminal device each obtain the security context from a second NF, and each generate the first NAS key based on the obtained security context.

With reference to the third aspect, in some embodiments of the third aspect, the method further includes:

Neither the first NF nor the terminal device stores a NAS count of the first NF when the terminal device transitions from a connected state to an idle state or an inactive state; and the first NF and the terminal device each generate the first NAS key when the terminal device transitions from the idle state or the inactive state to the connected state, where the NAS count corresponding to the first NF starts from 0; or the NAS count corresponding to the first NF starts from the initial NAS count of the anchor function.

With reference to the third aspect, in some embodiments of the third aspect, the method further includes:

When a preset condition is met, the first NF updates the first NAS key generated by the first NF; the first NF sends a third message; and the terminal device receives the third message, and updates, based on the third message, the first NAS key generated by the terminal device.

With reference to the third aspect, in some embodiments of the third aspect, the method further includes:

A plurality of NFs directly connected to a radio access network device update a plurality of corresponding NAS keys when a preset condition is met; and when all the plurality of NFs successfully update the plurality of corresponding NAS keys, the anchor function sends a fourth message; and the terminal device receives the fourth message, and updates the plurality of NAS keys based on the fourth message.

With reference to the third aspect, in some embodiments of the third aspect, the method further includes:

The terminal device and the first NF receive a message from the anchor function, and suspend NAS message transmission between the first NF and the terminal device during updating of the first NAS key based on the received message.

With reference to the third aspect, in some embodiments of the third aspect, the method further includes:

The terminal device and the first NF receive a message from the anchor function, and resumes NAS message transmission between the first NF and the terminal device based on the received message.

With reference to the third aspect, in some embodiments of the third aspect, when the terminal device is handed over from the first NF to a first target NF, the method further includes:

The first NF sends security context of the terminal device; and the first target NF receives the security context of the terminal device.

With reference to the third aspect, in some embodiments of the third aspect, the security context of the terminal device includes security capability information of the terminal device, and the method further includes:

The first target NF selects a security algorithm based on the security capability information of the terminal device; the first target NF sends an identifier of the security algorithm selected by the first target NF; and the terminal device receives the identifier of the security algorithm selected by the first target NF.

According to a fourth aspect, a communication apparatus is provided. The communication apparatus may be a terminal device, or may be an apparatus (for example, a chip, a chip system, or a circuit) in the terminal device, or an apparatus that can be used together with the terminal device.

In a possible embodiment, the communication apparatus may include one-to-one corresponding modules or units to perform the methods/operations/steps/actions described in the first aspect. The module or the unit may be a hardware circuit, may be software, or may be implemented by a hardware circuit in combination with software.

According to a fifth aspect, a communication apparatus is provided. The communication apparatus may be a first NF, or may be an apparatus (for example, a chip, a chip system, or a circuit) in the first NF, or an apparatus that can be used together with the first NF.

In a possible embodiment, the communication apparatus may include one-to-one corresponding modules or units to perform the methods/operations/steps/actions related to the first NF in the second aspect. The module or the unit may be a hardware circuit, may be software, or may be implemented by a hardware circuit in combination with software.

According to a sixth aspect, a communication apparatus is provided, including a communication interface and a processor. The communication interface is configured to output and/or input a signal, and the processor is configured to execute a computer program or instructions stored in a memory, to enable the communication apparatus to perform the method of the first aspect or the second aspect.

Optionally, the memory may be included in the communication apparatus. In a manner, the memory and the processor may be disposed separately. In another manner, the memory may be located in the processor and integrated with the processor.

Optionally, the memory may alternatively be outside the communication apparatus and coupled to the processor.

According to a seventh aspect, a non-transitory computer-readable storage medium is provided, and includes a computer program. When the computer program is run on a computer, the computer is enabled to perform the method according to any one of the possible embodiments of the first aspect or the second aspect.

According to an eighth aspect, a chip or a chip system is provided. The chip or the chip system includes a processing circuit and an input/output interface. The processing circuit is configured to perform the method according to any one of the possible embodiments of the first aspect or the second aspect.

According to a ninth aspect, a computer program product is provided. The computer program product includes a computer program (which may also be referred to as code or instructions). When the computer program is run, a computer is enabled to perform the method according to any one of the possible embodiments of the first aspect or the second aspect.

According to a tenth aspect, a communication system is provided, including a plurality of NFs directly connected to a base station and a terminal device. The terminal device is configured to perform the method in any possible embodiment of the first aspect, the plurality of NFs directly connected to the base station include a first NF, and the first NF is configured to perform the method in any possible embodiment of the second aspect.

### BRIEF DESCRIPTION OF DRAWINGS

FIG. 1 shows a communication system;

FIG. 2 shows another communication system;

FIG. 3 is a schematic flowchart 1 of a NAS message processing method according to the embodiments;

FIG. 4 is a schematic flowchart 2 of a NAS message processing method according to the embodiments;

FIG. 5 is a schematic flowchart of a NAS entity suspension method;

FIG. 6 is a schematic flowchart of a NAS entity deletion method;

FIG. 7 is a schematic flowchart of a NAS key deactivation method;

FIG. 8 is a schematic flowchart of a NAS key generation method when a terminal device transitions to a connected state;

FIG. 9 is a schematic flowchart of a method for independently updating a NAS key by a terminal device and a first NF;

FIG. 10 is a schematic flowchart of a method for jointly updating a NAS key by a terminal device and a plurality of NFs;

FIG. 11 is a schematic flowchart of a method for generating a NAS key by a first target NF in a handover scenario;

FIG. 12 is a block diagram of a communication apparatus according to the embodiments; and

FIG. 13 is another block diagram of a communication apparatus according to the embodiments.

### DETAILED DESCRIPTION OF EMBODIMENTS

To make objectives, solutions, and advantages clearer, the following further describes the embodiments in detail with reference to the accompanying drawings. An operation method in a method embodiment may also be applied to an apparatus embodiment or a system embodiment. In the descriptions of the embodiments, unless otherwise specified, a plurality of means two or more than two.

In various embodiments, unless otherwise stated or there is a logic conflict, terms and/or descriptions in different embodiments are consistent and may be mutually referenced, and features in different embodiments may be combined into a new embodiment based on an internal logical relationship thereof.

It may be understood that various numerals used in the embodiments are differentiated for ease of description, and are not intended to limit the description herein. Sequence numbers of the foregoing processes do not mean an execution sequence, and the execution sequence of the processes may be determined based on functions and internal logic of the processes.

In the embodiments, claims, and accompanying drawings of the embodiments, the terms “first”, “second”, “third”, “fourth”, various other term numerals, and the like (if existent) are intended to distinguish between similar objects but do not describe an order or sequence. It may be understood that the data termed in such a way are interchangeable in proper circumstances so that embodiments described herein can be implemented in other orders than the order illustrated or described herein. In addition, the terms “include” and “have” and any other variants are intended to cover the non-exclusive inclusion. For example, a process, method, system, product, or device that includes a list of steps or operations or units may not be limited to those expressly listed steps or operations or units, but may include other steps or operation or units not expressly listed or inherent to such a process, method, product, or device.

It may be understood that in the embodiments, “indicate” may include two manners: “directly indicate”and “indirectly indicate”.

The network architecture and the service scenario described in embodiments are intended to describe the solutions in embodiments more clearly, and do not constitute a limitation on the solutions provided herein. A person of ordinary skill in the art may know that: with the evolution of the network architecture and the emergence of new service scenarios, the solutions provided in embodiments are also applicable to similar problems.

The solutions provided in the embodiments may be applied to various communication systems, for example, a 5^{th} generation (5G) or new radio (NR) system, a long term evolution (LTE) system, an LTE frequency division duplex (FDD) system, and an LTE time division duplex (TDD) system. The solutions provided in the embodiments may be further applied to a future communication system, for example, a 6^{th} generation (6G) mobile communication system. The solutions provided in the embodiments may also be applied to device-to-device (D2D) communication, vehicle-to-everything (V2X) communication, machine-to-machine (M2M) communication, machine type communication (MTC), an Internet of Things (IoT) communication system, or another communication system.

For ease of understanding, the following describes some terms.

### 1. Terminal Device

In embodiments, the terminal device may be user equipment (UE), a mobile station (MS), a mobile terminal (MT), an access terminal, a subscriber unit, a subscriber station, a mobile station, a remote station, a remote terminal, a mobile device, a user terminal, a terminal, a wireless communication device, a user agent, a user apparatus, or the like.

The terminal device may be a device that provides voice/data connectivity for a user, for example, a handheld device or a vehicle-mounted device that has a wireless connection function. Examples of the terminal device are as follows: a mobile phone, a tablet computer, a notebook computer, a palmtop computer, a mobile internet device (MID), a wearable device, a virtual reality (VR) device, an augmented reality (AR) device, a wireless terminal in industrial control, a wireless terminal in self-driving (or autopilot), a wireless terminal in remote medical surgery, a wireless terminal in a smart grid, a wireless terminal in transportation safety, a wireless terminal in a smart city, a wireless terminal in a smart home, a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, a vehicle-mounted device, a wearable device, a terminal device in a future 5G network, a terminal device in a future evolved public land mobile network (PLMN), and the like. This is not limited herein.

As an example instead of a limitation, in embodiments, the terminal device may alternatively be a wearable device. The wearable device may also be referred to as a wearable intelligent device, and is a general term of a wearable device that is intelligently designed and developed for daily wear by using a wearable technology, for example, glasses, gloves, a watch, clothing, and shoes. The wearable device is a portable device that can be directly worn on the body or integrated into clothes or an accessory of a user. The wearable device is not only a hardware device, but also implements a powerful function through software support, data exchange, and cloud interaction. In a broad sense, wearable intelligent devices include full-featured and large-sized devices that can implement complete or partial functions without depending on smartphones, such as smart watches or smart glasses, and devices that dedicated to only one type of application function and may work with other devices such as smartphones, such as various smart bands or smart jewelry for monitoring physical signs. In addition, in embodiments, the terminal device may alternatively be a terminal device in an Internet of Things (IoT) system.

### 2. Network Function (NF)

In embodiments, the NF may include a radio access network (RAN) network function and a core network (CN) network function. In addition, the NF may be a network physical entity, or may be a logical function. This is not limited. The network function may also be referred to as a network element.

The RAN in embodiments may be an access network, or may refer to an access network device. This is not distinguished herein. The access network device is a device that provides a wireless communication function for a terminal device, and may also be referred to as an access device, a network device, a radio access network device, or the like. The access network device includes but is not limited to a next generation NodeB (gNB) in a 5G system, an evolved NodeB (eNB) in an LTE system, a radio network controller (RNC), a NodeB (NB), a base station controller (BSC), a base transceiver station (BTS), a home NodeB (HNB), a baseband unit (BBU), a transmitting and receiving point (TRP), a transmitting point (TP), a small base station device (pico), a mobile switching center, or a network device in a future network. It may be understood that a type of the access network device is not limited by the description herein. In systems using different radio access technologies, devices with functions of the access network device may have different names.

Optionally, in some deployments of the access device, the access device may include a central unit (CU), a distributed unit (DU), and the like. In some other deployments of the access device, the CU may be further split into a CU-control plane (CP), a CU-user plane (UP), and the like. In still some other deployments of the access device, the access device may alternatively be in an open radio access network (ORAN) architecture or the like. A deployment manner of the access device is not limited by the description herein.

The following uses a 5G system as an example to describe a control plane CN NF. In 5G, the control plane CN NF includes an AMF, a session management function (SMF), a policy control function (PCF), a location management function (LMF), and the like. It may be understood that the 5G system further includes another type of NF. Details are not described herein again.

### (1) AMF

The AMF may be configured for mobility management, access management, and the like, and may be configured to implement a function in a mobility management entity (MME) function other than session management, for example, a legal detection function or an access authorization function. In addition, the AMF is further configured to transmit a user policy between a terminal device and a PCF.

In addition, a name of the AMF in a future communication system is not limited by the description herein.

### (2) SMF

The SMF may be configured for session management, allocation and management of an internet protocol (IP) address of a terminal device, and selection and management of a user plane function (UPF) network element, a termination point of a policy control and charging function interface, a downlink data notification, and the like.

In addition, a name of the SMF in a future communication system is not limited by the description herein.

### (3) PCF

The PCF may provide policy rule information and the like for a control plane function network element (for example, an access and mobility management function network element or a session management function network element). The PCF can be responsible for policy control such as session-level or service flow-level charging, QoS bandwidth guarantee and mobility management, and terminal device policy decision-making. The PCF may have both a capability of an access and mobility management policy control network element (policy control function for access and mobility control, AM PCF) and a capability of a session management policy control network element (PCF for session management, SM PCF). Logically, the AM PCF and the SM PCF may be understood as different network functions having different capabilities. In some embodiments, the AM PCF and the SM PCF may be a same policy control network element entity, or may be two different policy control network element entities.

For example, the AM PCF is directly connected to the AMF, and the AM PCF provides the AMF with mobility and an access selection related policy of the terminal device. A mobility policy includes, for example, service area restriction management and radio access technology frequency selection priority (RFSP) index management.

In addition, a name of the PCF in a future communication system is not limited by the description herein.

### (4) LMF

The LMF may be configured to interact with a 5G core network, to complete a positioning function of a terminal. In addition, a name of the LMF in a future communication system is not limited by the description herein.

### (5) Anchor Function

In embodiments, the anchor function may be understood as a network function that generates a NAS root key.

In a 5G system, the anchor function may be an AMF. An NF that can serve as an anchor function in a future communication system is not limited by the description herein. For example, in a future communication system, the anchor function may still be an AMF, or, in another embodiment, may be another NF. This is not limited.

The following describes a problem addressed in the embodiments.

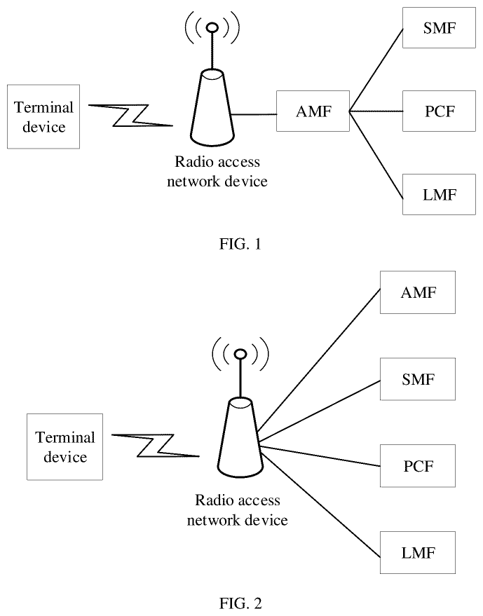

As shown in FIG. 1, in a 5G system, a radio access network device is directly connected to (a “direct connection” for short) an AMF, and is not directly connected to another control plane CN NF (for example, an SMF, a PCF, or an LMF). Therefore, a message (for example, an Ng message and a NAS message) between another CN NF (an NF that is not directly connected to the radio access network device) and the radio access network device may be transmitted through the AMF, or the AMF is an agent between the radio access network device and another CN NF. This architecture causes a transmission latency, and therefore is not friendly to a latency-sensitive service (for example, an ultra-reliable low-latency communication (ultra-reliable low-latency communication (URLLC) service).

As shown in FIG. 2, in an embodiment, in a future communication system, the radio access network device may be directly connected to a plurality of types of control plane CN NFs. In other words, the radio access network device may directly communicate with the plurality of types of control plane CN NFs. For example, in addition to being directly connected to the AMF, the radio access network device may be directly connected to one or more of the SMF, the PCF, and the LMF. Based on a communication architecture shown in FIG. 2, the transmission delay may be reduced. The SMF is used as an example. In an architecture in FIG. 1, communication between the terminal device and the SMF passes through the radio access network device and the AMF. In the architecture in FIG. 2, communication between a terminal device and the SMF may not pass through the AMF, thereby reducing the transmission latency.

Optionally, in another manner, in a future communication system, although the radio access network device is directly connected to the plurality of types of control plane CN NFs, the radio access network device may alternatively communicate with the CN NF through an anchor function.

In other words, the future communication system may include the anchor function and a non-anchor function. For example, the anchor function is an AMF, and the non-anchor function includes an SMF, an LMF, a PCF, and the like. The radio access network device may communicate with the SMF, the LMF, or the PCF through the AMF.

In another embodiment, the future communication system may alternatively not include the anchor function. This is not limited herein.

It may be understood that, with development of technologies, an existing NAS security mechanism is not applicable to the future communication system in which the radio access network device is directly connected to the plurality of types of control plane CN NFs.

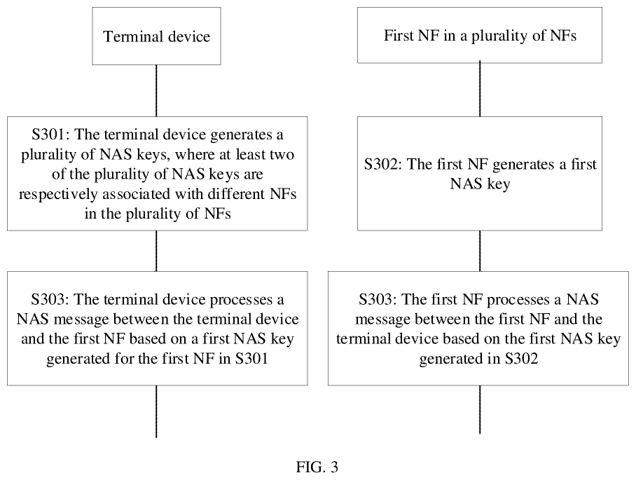

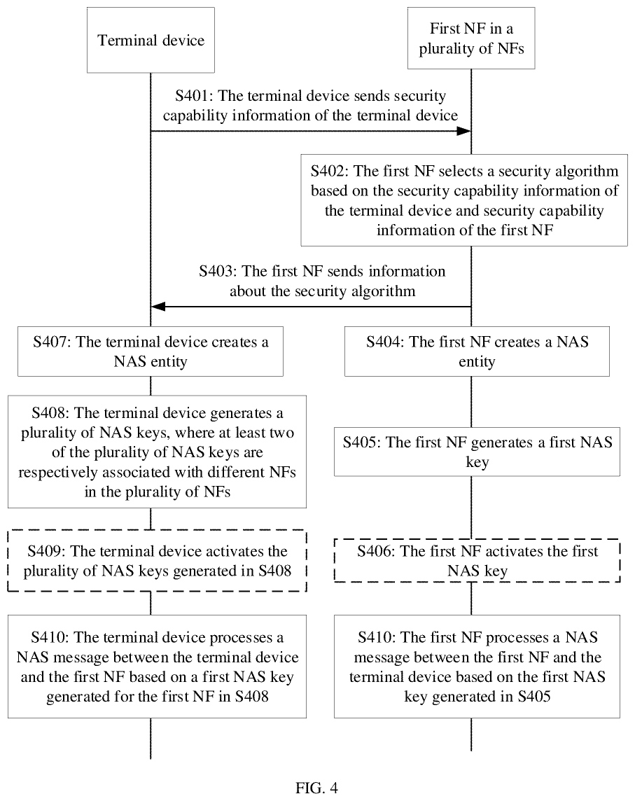

Based on the foregoing problem, the embodiments provide a method 300. It may be understood that the method 300 is applicable to a future communication system (for example, the communication system shown in FIG. 2). For example, as shown in FIG. 3, the method 300 includes the following steps or operations.

S301: a terminal device generates a plurality of NAS keys, where at least two of the plurality of NAS keys are respectively associated with different NFs in a plurality of NFs.

For a mechanism in which the terminal device generates the plurality of NAS keys, refer to the method 400. Details are not described herein.

For example, the terminal device may generate a key associated with an SMF, where the key is denoted as K_{SMF}. Further, the terminal device may generate, based on K_{SMF}, a NAS key for encryption/decryption of a NAS message (such as, a NAS message between the terminal device and the SMF), where the NAS key is denoted as K_{NASsmf-enc}, and a NAS key for integrity protection (“integrity protection” for short) of the NAS message, where the NAS key is denoted as K_{NASsmf-int}. K_{NASsmf-enc} and K_{NASsmf-int} are also keys associated with the SMF.

It may be understood that the terminal device may generate one or more of K_{SMF}, K_{NASsmf-enc}, and K_{NASsmf-int}. For example, the terminal device may not generate K_{NASsmf-enc} when an encryption/decryption function for the NAS message between the terminal device and the SMF may not be enabled. For example, the terminal device may not generate K_{NASsmf-int} when an integrity protection function for the NAS message between the terminal device and the SMF may not be enabled. For example, when neither an encryption/decryption function nor an integrity protection function for the NAS message between the terminal device and the SMF may not be enabled, the terminal device may generate K_{SMF}, and does not generate K_{NASsmf-enc} or K_{NASsmf-int}.

In addition, optionally, for a same terminal device, different PDU sessions may correspond to different SMF entities. Therefore, when generating K_{SMF}, K_{NASsmf-enc}, and K_{NASsmf-int}, the terminal device may generate these keys at a granularity of a PDU session. For example, for a PDU session #1, the terminal device may generate one or more of K_{SMF} #1, K_{NASsmf-enc} #1, and K_{NASsmf-int} #1. Optionally, if there is another PDU session, for example, a PDU session #2, the terminal device may generate one or more of K_{SMF} #2, K_{NASsmf-enc} #2, and K_{NASsmf-int} #2.

It may be understood that the PDU session is associated with the SMF entity, and the SMF entity associated with the PDU session changes with a handover procedure performed by the terminal device. For example, before a handover, the PDU session #1 is associated with an SMF #1, and the PDU session #2 is associated with an SMF #2. After the handover, both the PDU session #1 and the PDU session #2 are associated with an SMF #3. If a NAS key is generated at a granularity of an SMF, after a handover, a NAS key of the PDU session #1 and a NAS key of the PDU session #2 may be the same, causing a conflict. Therefore, the terminal device generates a NAS key at a granularity of a PDU session. This is more flexible in a handover scenario, thereby reducing a conflict probability.

The terminal device may further generate a key associated with an LMF, where the key is denoted as K_{LMF}. Further, the terminal device may generate, based on K_{LMF}, a key for encryption/decryption of a NAS message (such as, a NAS message between the terminal device and the LMF), where the key is denoted as K_{NASlmf-enc}, and a key for integrity protection of the NAS message, where the key is denoted as K_{NASlmf-int}. K_{NASlmf-enc} and K_{NASlmf-int} are also keys associated with the LMF.

It may be understood that the terminal device may generate one or more of K_{LMF}, K_{NASlmf-enc}, and K_{NASlmf-int}. For example, the terminal device may not generate K_{NASlmf-enc} when an encryption/decryption function for the NAS message between the terminal device and the LMF may not be enabled. For example, the terminal device may not generate K_{NASlmf-int} when an integrity protection function for the NAS message between the terminal device and the LMF may not be enabled. For example, when neither an encryption/decryption function nor an integrity protection function for the NAS message between the terminal device and the LMF may not be enabled, the terminal device may generate K_{LMF}, and does not generate K_{NASlmf-enc} or K_{NASlmf-int}.

The terminal device may further generate a key associated with a PCF, where the key is denoted as K_{PCF}. Further, the terminal device may generate, based on K_{PCF}, a key for encryption/decryption of a NAS message (such as, a NAS message between the terminal device and the PCF), where the key is denoted as K_{NASpef-enc}, and a key for integrity protection of the NAS message, where the key is denoted as K_{NASpef-int}. K_{NASpef-enc} and K_{NASpef-int} are also keys associated with the PCF.

It may be understood that the terminal device may generate one or more of K_{PCF}, K_{NASpef-enc}, and K_{NASpef-int}. For example, the terminal device may not generate K_{NASpcf-enc} when an encryption/decryption function for the NAS message between the terminal device and the PCF may not be enabled. For example, the terminal device may not generate K_{NASpef-int} when an integrity protection function for the NAS message between the terminal device and the PCF may not be enabled. For example, when neither an encryption/decryption function nor an integrity protection function for the NAS message between the terminal device and the PCF may not be enabled, the terminal device may generate K_{PCF}, and does not generate K_{NASpef-enc} or K_{NASpef-int}.

The terminal device may further generate a key associated with an AMF, where the key is denoted as K_{AMF}. Further, the terminal device may generate, based on K_{AMF}, a key for encryption/decryption of a NAS message (such as, a NAS message between the terminal device and the AMF), where the key is denoted as K_{NASamf-enc}, and a key for integrity protection of the NAS message, where the key is denoted as K_{NASamf-int}. K_{NASamf-enc} and K_{NASamf-int} are also keys associated with the AMF.

It may be understood that the terminal device may generate one or more of K_{AMF}, K_{NASamf-enc}, and K_{NASamf-int}. For example, the terminal device may not generate K_{NASamf-enc} when an encryption/decryption function for the NAS message between the terminal device and the AMF may not be enabled. For example, the terminal device may not generate K_{NASamf-int} when an integrity protection function for the NAS message between the terminal device and the AMF may not be enabled. For example, when neither an encryption/decryption function nor an integrity protection function for the NAS message between the terminal device and the AMF may not be enabled, the terminal device may generate K_{AMF}, and does not generate K_{NASamf-enc} or K_{NASamf-int}.

The following uses several examples to describe “at least two of a plurality of keys are respectively associated with different network functions”.

### Example 1

A plurality of keys generated by the terminal device include K_{AMF} and K_{PCF}. K_{AMF} is associated with the AMF, and K_{PCF} is associated with the PCF. In other words, K_{AMF} and K_{PCF} are respectively associated with different NFs.

### Example 2

A plurality of keys generated by the terminal device include K_{AME}, K_{SMF} #1 for the PDU session #1, and K_{SMF} #2 for the PDU session #2. K_{AMF} is associated with the AMF, and K_{SMF} #1 and K_{SMF} #2 are associated with a same SMF. In other words, K_{AMF} and K_{SMF} #1 are respectively associated with different NFs, and K_{AMF} and K_{SMF} #2 are respectively associated with different NFs.

### Example 3

A plurality of keys generated by the terminal device include K_{AMF}, K_{PCF}, and K_{LMF}. K_{AMF} is associated with the AMF, K_{PCF} is associated with the PCF, and K_{LMF} is associated with the LMF. In other words, K_{AMF}, K_{PCF}, and K_{LMF} are respectively associated with different NFs.

### Example 4

A plurality of keys generated by the terminal device include K_{AMF}, K_{PCF}, K_{LMF}, and K_{SMF}. K_{AMF} is associated with the AMF, K_{PCF} is associated with the PCF, K_{LMF} is associated with the LMF, and K_{SMF} is associated with the SMF. In other words, K_{AMF}, K_{PCF}, K_{LMF}, and K_{SMF} are respectively associated with different NFs.

In this embodiment, from a perspective of a network side, a plurality of NFs directly connected to a radio access network device each generate a corresponding NAS key. For example, the plurality of NFs directly connected to the radio access network device include an NF #1, an NF #2, and an NF #3. The NF #1 generates a NAS key #1, the NF #2 generates a NAS key #2, and the NF #3 generates a NAS key #3. The following provides descriptions by using an example in which a first NF generates a first NAS key. The first NF is one of the plurality of NFs.

S302: the first NF generates the first NAS key.

The first NF is any one of the plurality of NFs corresponding to the plurality of NAS keys generated by the terminal device.

It may be understood that the plurality of NFs are NFs directly connected to the radio access network device. The first NF may have an anchor function (such as, the first NF is an anchor function), or may not have an anchor function (such as, the first NF is a non-anchor function).

For a mechanism in which the first NF generates the first NAS key, refer to the method 400. Details are not described herein.

For example, the first NF is an SMF, and the SMF may generate K_{SMF}. Optionally, the SMF may generate, based on K_{SMF}, a key for encryption/decryption of a NAS message (such as, a NAS message between the terminal device and the SMF), where the key is denoted as K_{NASsmf-enc}; and/or generate, based on K_{SMF}, a key for integrity protection of the NAS message, where the key is denoted as KNASsmf-int.

It may be understood that the first NF determines, based on whether an encryption/decryption function for the NAS message may be enabled, whether to generate a NAS key related to encryption/decryption. Similarly, the first NF determines, based on whether an integrity protection function for the NAS message may be enabled, whether to generate a NAS key related to integrity protection.

Similar to the terminal device, optionally, the SMF may generate one or more of K_{SMF}, K_{NASsmf-enc}, and K_{NASsmf-int} at a granularity of a PDU session. According to this embodiment, the SMF generates a NAS key at a granularity of a PDU session, to avoid a case in which different SMFs generate a same NAS key for a same terminal device, thereby reducing a conflict probability.

For another example, the first NF is an LMF, and the LMF may generate K_{LMF}. Optionally, the LMF may generate, based on K_{LMF}, a key for encryption/decryption of a NAS message (such as, a NAS message between the terminal device and the LMF), where the key is denoted as K_{NASlmf-enc}; and/or generate, based on K_{LMF}, a key for integrity protection of the NAS message, where the key is denoted as K_{NASlmf-int}.

For another example, the first NF is a PCF, and the PCF may generate K_{PCF}. Optionally, the PCF may generate, based on K_{PCF}, a key for encryption/decryption of a NAS message (such as, a NAS message between the terminal device and the PCF), where the key is denoted as K_{NASpef-enc}; and/or generate, based on K_{PCF}, a key for integrity protection of the NAS message, where the key is denoted as K_{NASpcf-int}.

For another example, the first NF is an AMF, and the AMF may generate K_{AMF}. Optionally, the first NF may generate K_{NASamf-enc} and/or K_{NASamf-int} based on K_{AMF}.

S303: the first NF processes a NAS message between the first NF and the terminal device based on the first NAS key generated in S302. Correspondingly, the terminal device processes a NAS message between the terminal device and the first NF based on the first NAS key generated for the first NF in S301.

### Downlink Transmission is Used as an Example

The first NF may encrypt the NAS message based on the first NAS key generated in S302, and send the NAS message. Correspondingly, the terminal device may receive the NAS message, and decrypt the NAS message based on the first NAS key generated in S301.

For example, the SMF may encrypt a NAS message for communication with a terminal device based on K_{NASsmf-enc}, and send a NAS message #1 to the terminal device. Correspondingly, the terminal device may receive the NAS message #1, and decrypt the NAS message #1 based on K_{NASsmf-enc}.

For another example, the LMF may encrypt a NAS message for communication with a terminal device based on K_{NASlmf-enc}, and send a NAS message #2 to the terminal device. Correspondingly, the terminal device may receive the NAS message #2, and decrypt the NAS message #2 based on K_{NASlmf-enc}.

For another example, the PCF may encrypt a NAS message for communication with a terminal device based on K_{NASpef-enc}, and send a NAS message #3 to the terminal device. Correspondingly, the terminal device may receive the NAS message #3, and decrypt the NAS message #3 based on the K_{NASpcf-enc}.

### Uplink Transmission is Used as an Example

The terminal device may encrypt the NAS message based on the first NAS key generated in S301, and send the NAS message. Correspondingly, the first NF may receive the NAS message, and decrypt the NAS message based on the first NAS key generated in S302.

For example, the terminal device may encrypt a NAS message for communication with an SMF based on K_{NASsmf-enc}, and send a NAS message #a to the SMF. Correspondingly, the SMF may receive the NAS message #a, and decrypt the NAS message #a based on K_{NASsmf-enc}.

For another example, the terminal device may encrypt a NAS message for communication with an LMF based on K_{NASlmf-enc}, and send a NAS message #b to the LMF. Correspondingly, the LMF may receive the NAS message #b, and decrypt the NAS message #b based on K_{NASlmf-enc}.

For another example, the terminal device may encrypt a NAS message for communication with a PCF based on K_{NASpcf-enc}, and send a NAS message #c to the PCF. Correspondingly, the PCF may receive the NAS message #c, and decrypt the NAS message #c based on K_{NASpcf-enc}.

In addition, in a case, the first NAS key generated by the first NF in S302 may be the same as the first NAS key generated by the terminal device for the first NF in S301.

For example, in a symmetric encryption scenario, the SMF may encrypt the NAS message based on K_{NASsmf-enc}, and send the NAS message. After receiving the NAS message, the terminal device may decrypt the NAS message based on the same NAS key K_{NASsmf-enc}.

In another case, the first NAS key generated by the first NF in S302 may be different from the first NAS key generated by the terminal device for the first NF in S301.

For example, in an asymmetric encryption scenario, there are two types of keys: a private key and a public key. The SMF may encrypt the NAS message based on the public key K_{NASsmf-enc}, and send the NAS message. After receiving the NAS message, the terminal device may decrypt the NAS message based on a private key K_{NASsmf-enc}.

According to this embodiment, after the radio access network device is directly connected to a plurality of control plane CN NFs, the terminal device may generate one or more NAS keys associated with each of the plurality of CN NFs. Correspondingly, each of the plurality of CN NFs may also generate a NAS key, to process a NAS message (for example, perform encryption/decryption and/or integrity protection).

To better understand the method 300 provided in the embodiments, the following describes, with reference to the method 400, the method 300 in detail by using a first NF as an example. It may be understood that the first NF is any one of a plurality of NFs directly connected to a radio access network device. For example, the method 400 includes the following steps or operations.

S401: a terminal device sends security capability information of the terminal device to the first NF. Correspondingly, the first NF receives the security capability information from the terminal device.

For example, the first NF may have an anchor function (such as, the first NF is an anchor function), or may not have an anchor function (such as, the first NF is a non-anchor function). For example, the first NF may be any one of an AMF, an SMF, an LMF, or a PCF.

The following describes several manners in which the first NF obtains the security capability information of the terminal device.

### Manner 1

The terminal device directly sends the security capability information of the terminal device to the first NF.

For example, the terminal device may directly send a NAS message to the first NF. The NAS message includes the security capability information of the terminal device.

### Manner 2

The terminal device sends the security capability information to a radio access network device. Further, the radio access network device sends the security capability information of the terminal device to the first NF.

For example, the first NF is an SMF, and the terminal device may send the security capability information of the terminal device to the radio access network device. Further, the radio access network device sends the security capability information of the terminal device to the SMF.

In another case, the terminal device may send a NAS message to the radio access network device. The NAS message includes the security capability information of the terminal device. The radio access network device does not parse the NAS message. Further, the radio access network device sends the NAS message to the first NF. For example, the NAS message is transparently transmitted by the radio access network device.

### Manner 3

The terminal device sends the security capability information to an anchor function (for example, an AMF). Further, the anchor function sends the security capability information of the terminal device to the first NF. In Manner 3, the first NF is not an anchor function. In other words, the first NF is a non-anchor function.

For example, the first NF is an LMF, and the terminal device may send the security capability information of the terminal device to the AMF. Further, the AMF sends the security capability information of the terminal device to the LMF.

In a case, the terminal device may send a NAS message to the anchor function. The NAS message includes the security capability information of the terminal device. Further, the anchor function may send the NAS message to the first NF. For example, the NAS message is transparently transmitted by the anchor function.

### Manner 4

The terminal device may send the security capability information of the terminal device to a radio access network device. Further, the radio access network device sends the security capability information of the terminal device to an anchor function (for example, an AMF). Further, the anchor function sends the security capability information of the terminal device to the first NF.

It may be understood that, in Manner 4, the first NF is not an anchor function.

For example, the first NF is an SMF, and the terminal device may send the security capability information of the terminal device to the SMF through the radio access network device and the AMF.

In a case, the terminal device may send a NAS message to the radio access network device. The NAS message includes the security capability information of the terminal device. Further, the radio access network device sends the NAS message to the anchor function. Further, the anchor function may send the NAS message to the first NF. For example, the NAS message is transparently transmitted by the anchor function and the radio access network device.

S402: the first NF selects a security algorithm based on the security capability information of the terminal device and security capability information of the first NF.

S403: the first NF sends information about the security algorithm. Correspondingly, the terminal device receives the information about the security algorithm.

The information about the security algorithm indicates the security algorithm selected by the first NF in S402. For example, the information about the security algorithm is an identifier of the security algorithm.

The following describes several manners in which the terminal device obtains the information about the security algorithm.

### Manner 1

The first NF sends the information about the security algorithm to an anchor function (for example, an AMF). Further, the anchor function sends the information about the security algorithm to the terminal device.

It may be understood that, in Manner 1, the first NF is not an anchor function. In other words, the first NF is a non-anchor function.

For example, the first NF is an SMF. After selecting the security algorithm, the SMF may send, to the terminal device through the AMF, the identifier of the security algorithm selected by the SMF.

In a case, the first NF may send a NAS message to the anchor function. The NAS message includes the information about the security algorithm. Further, the anchor function sends the NAS message to the terminal device. For example, the NAS message is transparently transmitted by the anchor function.

### Manner 2

The first NF directly sends the information about the security algorithm to the terminal device.

In a case, the first NF may send a NAS message to the terminal device. The NAS message includes the information about the security algorithm.

### Manner 3

The first NF sends the information about the security algorithm to a radio access network device. Further, the radio access network device sends the information about the security algorithm to the terminal device.

For example, the first NF is a PCF. After selecting the security algorithm, the PCF may send, to the terminal device through the radio access network device, the identifier of the security algorithm selected by the PCF.

In a case, the first NF may send a NAS message to the radio access network device. The NAS message includes the information about the security algorithm. Further, the radio access network device may send the NAS message to the terminal device. For example, the NAS message is transparently transmitted by the radio access network device.

### Manner 4

The first NF may send the information about the security algorithm to an anchor function (for example, an AMF). Further, the anchor function sends the information about the security algorithm to a radio access network device. Further, the radio access network device sends the information about the security algorithm to the terminal device.

It may be understood that, in Manner 4, the first NF is not an anchor function.

For example, the first NF is an SMF, and the SMF may send, to the terminal device through the AMF and the radio access network device, the identifier of the security algorithm selected by the SMF.

In a case, the first NF may send a NAS message to the anchor function. The NAS message includes the information about the security algorithm. Further, the anchor function may send the NAS message to the radio access network device. Further, the radio access network device may send the NAS message to the terminal device. For example, the NAS message is transparently transmitted by the anchor function and the radio access network device.

S404: the first NF creates (or establishes) a NAS entity.

It may be understood that the NAS entity may be configured to: generate a NAS message, encrypt the NAS message, decrypt the NAS message, perform integrity protection on the NAS message, and maintain a NAS security context.

The following describes, in different cases, a trigger condition for creating the NAS entity by the first NF.

### Case 1

The first NF creates a NAS entity corresponding to the first NF after successfully performing access authentication on the terminal device.

For example, the first NF is a PCF. When the PCF successfully performs access authentication on the terminal device, the PCF creates a NAS entity corresponding to the PCF, where the NAS entity is denoted as a NASpcf entity.

### Case 2

The first NF receives a message #A, and creates a NAS entity corresponding to the first NF based on the message #A. It may be understood that the message #A may be from any one of the terminal device, the radio access network device, the AMF (in this case, the first NF is not an AMF), an enhanced serving mobile location center (E-SMLC), and a secure user plane location (SUPL) location platform (SLP).

For example, the first NF is an SMF. For example, the message #A may explicitly indicate an SMF to create a NAS entity corresponding to the SMF, where the NAS entity is denoted as a NASsmf entity. For example, the message #A may include 1 bit. When a value of the bit is “1”, the message #A indicates the SMF to create the NASsmf entity.

Alternatively, the message #A may implicitly indicate an SMF to create a NASsmf entity (for example, the message #A is a PDU session create message (PDU session create message)). In other words, the PDU session create message may be reused to implicitly indicate the SMF to create the NASsmf entity.

For example, the first NF is an LMF. For example, the message #A may explicitly indicate an LMF to create a NAS entity corresponding to the LMF, where the NAS entity is denoted as a NASlmf entity. For example, the message #A may include 1 bit. When a value of the bit is “1”, the message #A indicates the LMF to create the NASlmf entity.

Alternatively, the message #A may implicitly indicate an LMF to create a NASlmf entity (for example, the message #A is a location service start message). In other words, the location service start message may be reused to implicitly indicate the LMF to create the NASlmf entity.

For example, the first NF is a PCF. For example, the message #A may explicitly indicate a PCF to create a NASpcf entity. For example, the message #A may include 1 bit. When a value of the bit is “1”, the message #A indicates the PCF to create the NASpcf entity.

Alternatively, the message #A may implicitly indicate a PCF to create a NASpcf entity. For example, the message #A may be an AM policy association establishment message, an AM policy association modification message, a UE policy association establishment message, or the like sent by the AMF to the PCF. For example, an existing message may be reused to implicitly indicate the PCF to create the NASpcf entity.

S405: the first NF generates a first NAS key.

It may be understood that an execution sequence of S404 and S405 is not limited by the description herein. For example, S404 may be performed before S405, or may be performed after S405.

For example, the first NF may obtain a NAS root key, and generate the first NAS key based on the NAS root key. It may be understood that the first NF may generate the NAS root key if the first NF is an anchor function. If the first NF is not an anchor function, the first NF may obtain the NAS root key from the anchor function (for example, an AMF). For example, an NF such as an SMF, a PCF, or an LMF may obtain the NAS root key from the AMF.

For example, the NAS root key is a key corresponding to a security anchor function and is denoted as K_{SEAF}; or the NAS root key is a key corresponding to an access and mobility management function and is denoted as K_{AMF}; or the NAS root key is a key (which is not K_{AMF}, in other words, different from K_{AMF}) derived based on K_{SEAF}; or the NAS root key is a key derived based on K_{AMF}.

The following describes, by using an example in which the NAS root key is K_{SEAF} or K_{AMF}, a process in which the first NF generates the first NAS key.

### (1) The NAS Root Key is K_{SEAF}

The first NF is an SMF, and the SMF generates K_{SMF} based on K_{SEAF}. Optionally, the SMF may generate K_{NASsmf-enc} and/or K_{NASsmf-int} based on K_{SMF}.

Alternatively, the first NF is an LMF, and the LMF generates K_{LMF} based on K_{SEAF}. Optionally, the LMF may generate K_{NASlmf-enc} and/or K_{NASlmf-int} based on K_{LMF}.

Alternatively, the first NF is a PCF, and the PCF generates K_{PCF} based on K_{SEAF}. Optionally, the PCF may generate K_{NASpcf-enc} and/or K_{NASpcf-int} based on K_{PCF}.

Alternatively, the first NF is an AMF, and the AMF generates K_{AMF} based on K_{SEAF}. Optionally, the AMF may generate, based on K_{AMF}, a key for encryption/decryption of a NAS message (such as, a NAS message between the terminal device and the AMF), where the key is denoted as K_{NASamf-enc}; and/or a key for integrity protection of the NAS message, where the key is denoted as K_{NASamf-int}.

### (2) The NAS Root Key is K_{AMF}

The first NF is an SMF, and the SMF generates K_{SMF} based on K_{AMF}. Optionally, the SMF may generate K_{NASsmf-enc} and/or K_{NASsmf-int} based on K_{SMF}.

Alternatively, the first NF is an LMF, and the LMF generates K_{LMF} based on K_{AMF}. Optionally, the LMF may generate K_{NASlmf-enc} and/or K_{NASlmf-int} based on K_{LMF}.

Alternatively, the first NF is a PCF, and the PCF generates K_{PCF} based on K_{AMF}. Optionally, the PCF may generate K_{NASpcf-enc} and/or K_{NASpcf-int} based on K_{PCF}.

Alternatively, the first NF is an AMF. Optionally, the AMF may generate K_{NASamf-enc} and/or K_{NASamf-int} based on K_{AMF}.

The following describes an input parameter used when the first NAS key is generated.

In this embodiment, the first NF may use one or more of a type parameter of the first NF, an identifier of the first NF, a NAS count of the first NF, an identifier of the security algorithm, and a PDU session identifier as the input parameter. The NAS count of the first NF may be maintained by the first NF. A combination form of the input parameter is not limited by the description herein. The following describes several possible cases of the input parameter. It may be understood that the following several cases are examples.

### Case 1

The first NF may use the type parameter of the first NF and/or the identifier of the first NF, the NAS count maintained by the first NF, and the identifier of the security algorithm (such as, the identifier of the security algorithm selected in S402) as the input parameter, and input the input parameter into a corresponding algorithm.

In this embodiment, “the type parameter of the first NF and/or the identifier of the first NF” may include three optional cases: “the type parameter of the first NF”, “the identifier of the first NF”, and “the type parameter of the first NF and the identifier of the first NF”. Details about this are not described again below.

For example, the first NF may input the input parameter into a next-generation encryption algorithm (NEA), for example, 128-NEA1, 128-NEA2, or 128-NEA3. Details about this are not described again below.

For example, the first NF is a PCF. When generating K_{PCF}, the PCF may use, as the input parameter, a type parameter of the PCF and/or an identifier of the PCF, a NAS count maintained by the PCF, and an identifier of a security algorithm selected by the PCF in S402.

For example, the first NF is an LMF. When generating K_{LMF}, the LMF may use, as the input parameter, a type parameter of the LMF and/or an identifier of the LMF, a NAS count maintained by the LMF, and an identifier of a security algorithm selected by the LMF in S402.

### Case 2

The first NF may use the type parameter of the first NF and/or the identifier of the first NF, the NAS count maintained by the first NF, the identifier of the security algorithm (such as, the identifier of the security algorithm selected in S402), and the PDU session identifier (PDU session id) as the input parameter.

For example, the first NF is an SMF. When generating KSMF, the SMF may use a type parameter of the SMF, a NAS count maintained by the SMF, an identifier of a security algorithm selected by the SMF in S402, and a PDU session identifier as the input parameter.

### Case 3

The first NF may use the NAS count maintained by the first NF, the identifier of the security algorithm (such as, the identifier of the security algorithm selected in S402), and the PDU session identifier as the input parameter.

For example, the first NF is an SMF. When generating KSMF, the SMF may use a NAS count maintained by the SMF, an identifier of a security algorithm selected by the SMF in S402, and a PDU session identifier as the input parameter.

It can be understood from Case 1 to Case 3 that, in this embodiment, each of the plurality of NFs directly connected to the radio access network device may maintain a NAS count.

In a manner, NAS counts maintained by the plurality of NFs directly connected to the radio access network device may start from 0.

In another manner, NAS counts maintained by the plurality of NFs directly connected to the radio access network device may start from an initial NAS count of an anchor function (for example, an AMF). The first NF in the plurality of NFs is used as an example. It may be understood that if the first NF is not an anchor function, the first NF (for example, an SMF, a PCF, or an LMF) may obtain the initial NAS count of the anchor function from the anchor function.

It may be understood that, in Case 1 to Case 3, a plurality of parameters are used as the input parameter, and a probability of a conflict between generated NAS keys is low.

### Case 4

The first NF may use only one of a type parameter of the first NF, an identifier of the first NF, a NAS count maintained by the first NF, an identifier of the security algorithm, and a PDU session identifier as the input parameter.

For example, the first NF may use only the type parameter of the first NF as the input parameter to generate a NAS key.

It may be understood that, using one parameter as the input parameter may simplify a NAS key generation mechanism, and reduce complexity of a NAS key generation algorithm.

S406: the first NF activates the first NAS key.

S406 is an optional step or operation. It may be understood that if the first NAS key is activated, the first NF may perform encryption/decryption and/or integrity protection on the NAS message. If the first NAS key is not activated, the NAS message may still be transmitted between the first NF and the terminal device.

The following describes a trigger condition for activating the first NAS key by the first NF.

### Case 1

The first NF activates the first NAS key when creating the NAS entity corresponding to the first NF.

For example, the PCF may activate K_{PCF} when creating the NASpcf entity, the LMF may activate K_{LMF} when creating the NASlmf entity, and the SMF may activate K_{SMF} when creating the NASsmf entity.

### Case 2

The first NF receives a message #B (such as, a fifth message), and activates the first NAS key based on the message #B.

For example, the message #B may be from any one of the terminal device, the radio access network device, the AMF (in this case, the first NF is not an AMF), the E-SMLC, and the SLP.

For example, the first NF is an SMF, and the SMF receives the PDU session create message (an example of the message #B). The PDU session create message may implicitly indicate the SMF to create a NAS entity and generate and activate a NAS key.

S407: the terminal device creates a NAS entity.

The following describes, in different cases, a trigger condition for creating the NAS entity by the terminal device.

### Case 1

The terminal device creates a NAS entity corresponding to the first NF after the terminal device accesses a core network for a first time and authentication succeeds.

For example, the terminal device creates one or more of a NASamf entity, a NASpcf entity, a NASsmf entity, and a NASlmf entity after the terminal device accesses the core network for the first time and authentication succeeds.

### Case 2

The terminal device receives a message #C, and creates a NAS entity corresponding to the first NF based on the message #C. Optionally, the message #C indicates an identifier of a NAS entity that may be created.

In an embodiment, the message #C may explicitly indicate the terminal device to create the NAS entity. For example, the message #C is a NAS security mode command (SMC) message. The NAS SMC message includes one or more bits, and the one or more bits may indicate the terminal device to create one or more of a NASamf entity, a NASpcf entity, a NASsmf entity, and a NASlmf entity.

For example, the AMF may send the NAS SMC message to the terminal device. Optionally, the SMF, the PCF, and the LMF may also send the NAS SMC message to the terminal device.

In another embodiment, the message #C may implicitly indicate the terminal device to create the NAS entity.

For example, the terminal device may send a PDU session create request message (PDU session create request message) to the network side, and the terminal device may receive a PDU session create accept message (PDU session create accept message) from the network side. After receiving the PDU session create accept message, the terminal device may establish one NASsmf entity for each PDU session.

For another example, the AMF may send a location service enabling message to the terminal device, and the terminal device creates the NASlmf entity after receiving the location service enabling message.

For another example, the LMF may send an LTE positioning protocol (LPP) request location information message to UE, and the terminal device creates the NASlmf entity based on the message.

S408: the terminal device generates a plurality of NAS keys. At least two of the plurality of NAS keys are respectively associated with different NFs in the plurality of NFs.

It may be understood that an execution sequence of S407 and S408 is not limited by the description herein. For example, S407 may be performed before S408, or may be performed after S408.

For example, the terminal device may generate the NAS key based on a NAS root key. Different from the network side, the terminal device may generate the NAS root key. For example, the terminal device may generate K_{AMF} or K_{SEAF}. For the NAS root key, refer to the foregoing descriptions.

The following describes, by using an example in which the NAS root key is K_{SEAF} or K_{AMF}, a process in which the terminal device generates the plurality of NAS keys.

### (1) The NAS Root Key is K_{SEAF}

The terminal device may generate K_{SMF} based on K_{SEAF}. Optionally, the terminal device may generate K_{NASsmf-enc} and/or K_{NASsmf-int} based on K_{SMF}.

The terminal device may generate K_{LMF} based on K_{SEAF}. Optionally, the terminal device may generate K_{NASlmf-enc} and/or K_{NASlmf-int} based on K_{LMF}.

The terminal device may generate K_{PCF} based on K_{SEAF}. Optionally, the terminal device may generate K_{NASpcf-enc} and/or K_{NASpef-int} based on K_{PCF}.

The terminal device may generate K_{AMF} based on K_{SEAF}. Optionally, the terminal device may generate K_{NASamf-enc} and/or K_{NASamf-int} based on K_{AMF}.

### (2) The NAS Root Key is K_{AMF}

The terminal device may generate K_{SMF} based on K_{AMF}. Optionally, the terminal device may generate K_{NASsmf-enc} and/or K_{NASsmf-int} based on K_{SMF}.

The terminal device may generate K_{LMF} based on K_{AMF}. Optionally, the terminal device may generate K_{NASlmf-enc} and/or K_{NASlmf-int} based on K_{LMF}.

The terminal device may generate K_{PCF} based on K_{AMF}. Optionally, the terminal device may generate K_{NASpcf-enc} and/or K_{NASpcf-int} based on K_{PCF}.

Optionally, the terminal device may generate K_{NASamf-enc} and/or K_{NASamf-int} based on K_{AMF}.

The plurality of NAS keys generated by the terminal device include a first key generated by the terminal device for the first NF. The following uses the first NF as an example to describe an input parameter used when the terminal device generates the first NAS key for the first NF.

For example, the terminal device may input the input parameter into the NEA, for example, 128-NEA1, 128-NEA2, or 128-NEA3.

In this embodiment, the terminal device may use one or more of a type parameter of the first NF, an identifier of the first NF, a NAS count of the first NF, an identifier of the security algorithm, and a PDU session identifier as the input parameter. The NAS count of the first NF may be maintained by the terminal device, or may be obtained from another NF. A combination form of the input parameter is not limited by the description herein. The following describes several possible cases of the input parameter. It may be understood that the following several cases are examples.

### Case A

The terminal device may use the type parameter of the first NF and/or the identifier of the first NF, the NAS count of the first NF, and the identifier of the security algorithm (such as, the identifier of the security algorithm received from the first NF in S403) as the input parameter.

For example, the first NF is a PCF. When generating K_{PCF}, the terminal device may use, as the input parameter, a type parameter of the PCF, a NAS count that is of the PCF and that is maintained by the terminal device, and an identifier of a security algorithm received from the PCF in S403.

For example, the first NF is an LMF. When generating K_{LMF}, the terminal device may use, as the input parameter, a type parameter of the LMF, a NAS count that is of the LMF and that is maintained by the terminal device, and an identifier of a security algorithm received from the LMF in S403.

### Case B

The terminal device may use the type parameter of the first NF and/or the identifier of the first NF, the NAS count of the first NF, the identifier of the security algorithm (such as, the identifier of the security algorithm received from the first NF in S403), and the PDU session identifier as the input parameter.

For example, the first NF is an SMF. When generating K_{SMF}, the terminal device may use a type parameter of the SMF, a NAS count that is of the SMF and that is maintained by the terminal device, an identifier of a security algorithm received from the SMF in S403, and the PDU session identifier as the input parameter.

### Case C

The terminal device may use the NAS count of the first NF, the identifier of the security algorithm (such as, the identifier of the security algorithm received in S403), and the PDU session identifier (PDU session id) as the input parameter.

For example, the first NF is an SMF. When generating K_{SMF}, the terminal device may use the NAS count that is of the SMF and that is maintained by the terminal device, the identifier of the security algorithm, and the PDU session identifier as the input parameter.

It can be understood from Case A to Case C that when the plurality of NFs each are directly connected to the radio access network device, the terminal device may maintain NAS counts of the plurality of NFs.

In a manner, a NAS count of each of the plurality of NFs may start from 0.

In another manner, a NAS count of each of the plurality of NFs may start from an initial NAS count of an anchor function (for example, an AMF). In this case, the terminal device may obtain the initial NAS count of the anchor function from the anchor function.

S409: the terminal device activates the plurality of NAS keys generated in S408.

The following uses the first NF as an example to describe a trigger condition for activating the first NAS key by the terminal device. The first NAS key is a NAS key generated by the terminal device for the first NF.

S409 is an optional step or operation. It may be understood that if the first NAS key is activated, the terminal device may perform encryption/decryption and/or integrity protection on the NAS message. If the first NAS key is not activated, the NAS message may still be transmitted between the first NF and the terminal device.

### Case 1

The terminal device activates the first NAS key when creating the NAS entity corresponding to the first NF.

For example, the first NF is an SMF. The terminal device activates K_{SMF}, K_{NASsmf-enc}, and K_{NASsmf-int} when the terminal device creates a NAS entity corresponding to the SMF.

### Case 2

The terminal device receives a message #D (such as, the first message), and activates the first NAS key based on the message #D.

For example, the AMF may send the message #D (for example, the message #D may be encrypted) to the terminal device, and the terminal device may activate, based on the message #D, a NAS key related to the AMF.

For another example, the SMF may send the message #D (for example, the message #D may be unencrypted) to the terminal device, and the terminal device may activate, based on the message #D, a NAS key associated with the SMF.

For another example, the PCF may send the message #D (for example, the message #D may be unencrypted) to the terminal device, and the terminal device may activate, based on the message #D, a NAS key associated with the PCF.

For another example, the LMF may send the message #D (for example, the message #D may be unencrypted) to the terminal device, and the terminal device may activate, based on the message #D, a NAS key associated with the LMF.

Optionally, the terminal device may send activation success information after the terminal device successfully activates the first NAS key. Correspondingly, the first NF receives the activation success information. The activation success information indicates that the terminal device successfully activates the first NAS key.

For example, the terminal device may directly send the activation success information to the first NF.

Alternatively, the terminal device may send the activation success information to the first NF through the radio access network device.

Alternatively, the terminal device may send the activation success information to the first NF through the radio access network device and the anchor function (for example, an AMF). It may be understood that, in this case, the first NF is not an anchor function.

It should be understood that, based on the activation success information, the first NF may determine that the terminal device successfully activates the first NAS key. Then, the first NF sends the NAS message to the terminal device. Based on this, a case in which the terminal device cannot process the NAS message (for example, the terminal device cannot decrypt the NAS message) because the first NF sends the NAS message but the terminal device does not activate the first NAS key can be avoided.

Optionally, the first NF may consider by default that the terminal device successfully activates the first NAS key. In this case, the terminal device may not send the activation success information to the first NF.

S410: the first NF processes a NAS message between the first NF and the terminal device based on the first NAS key generated in S405. Correspondingly, the terminal device processes a NAS message between the terminal device and the first NF based on the first NAS key generated for the first NF in S408.

In addition, in a case, the first NAS key generated by the first NF in S405 may be the same as the first NAS key generated by the terminal device for the first NF in S408. In a case, the first NAS key generated by the first NF in S405 may be different from the first NAS key generated by the terminal device for the first NF in S408. For this, refer to the foregoing descriptions. Details are not described again.

For the process, refer to the descriptions in S303.

Optionally, in the method 400, S401 to S403, S404 to S406, and S407 to S409 may be independent of each other. In other words, S404 to S406 may not depend on execution of S401 to S403 (or may not be performed based on S401 to S403), S407 to S409 may not depend on execution of S401 to S403, and S407 to S409 may not depend on execution of S404 to S406.

Optionally, all of S404 to S409 may be independent of each other. For example, each of S404 to S409 may be independently performed, and there is no dependency relationship between S404 to S409.

According to this embodiment, after the radio access network device is directly connected to a plurality of CN NFs, the terminal device may generate a NAS key associated with each of the plurality of CN NFs. Correspondingly, each of the plurality of CN NFs may also generate a NAS key, so that the terminal device and the plurality of CN NFs can process a NAS message (for example, perform encryption/decryption and integrity protection).

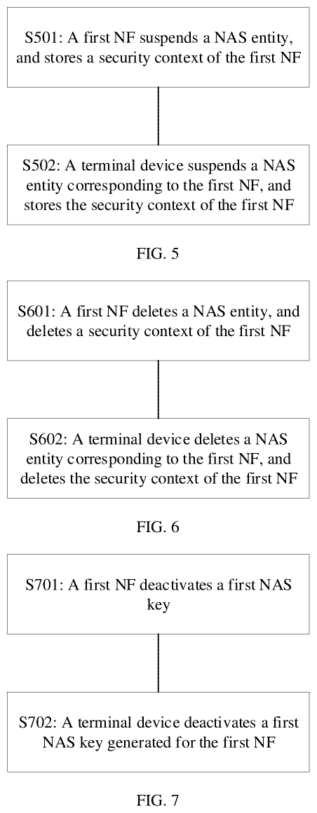

The embodiments further provide a NAS entity suspend mechanism in a NAS security mechanism. FIG. 5 shows a method 500 provided in the embodiments. It may be understood that, in an embodiment, the method 500 may be performed based on the method 400. For example, the method 500 includes the following steps or operations.

S501: a first NF suspends a NAS entity, and stores a security context of the first NF.

The security context of the first NF includes one or more of a NAS count of the first NF, an identifier of a security algorithm selected by the first NF, an identifier of a terminal device, a type of the first NF, an identifier of the first NF, and a PDU session identifier.

For example, the security context of the first NF includes the NAS count of the first NF, the identifier of the security algorithm selected by the first NF, and the identifier of the terminal device. Optionally, the security context of the first NF further includes one or more of the type of the first NF, the identifier of the first NF, and the PDU session identifier.

In other words, in this embodiment, each NF directly connected to a radio access network device maintains a NAS count. For example, an SMF may maintain a NAS count at a granularity of a PDU session. An AMF may maintain a NAS count of the AMF. An LMF may maintain a NAS count of the LMF. A PCF may maintain a NAS count of the PCF.

In an embodiment, the first NF receives a message #E, and suspends a NAS entity corresponding to the first NF based on the message #E. For example, the message #E may be sent by the terminal device, the radio access network device, or another CN NF.

### Example 1

The first NF is a PCF. The AMF may send a message #E1 to the PCF. The message #E1 indicates the PCF to suspend a NASpcf entity.

For example, the message #E1 may explicitly indicate the PCF to suspend the NASpcf entity. For example, the message #E1 may include 1 bit. When a value of the bit is “1”, the message #E1 indicates the PCF to suspend the NASpcf entity.

Alternatively, the message #E1 may implicitly indicate the PCF to suspend the NASpcf entity. For example, a message may be reused, and a message type of the message implicitly indicate the PCF to suspend the NASpcf entity.

### Example 2

The first NF is an SMF. The AMF may send a message #E2 to the SMF. The message #E2 indicates the SMF to suspend a NASsmf entity.

For example, the message #E2 may explicitly indicate the SMF to suspend the NASsmf entity. For example, the message #E2 may include 1 bit. When a value of the bit is “1”, the message #E2 indicates the SMF to suspend the NASsmf entity.

Alternatively, the message #E2 may implicitly indicate the SMF to suspend the NASsmf entity (for example, the message #E2 is a PDU session delete message). In other words, the PDU session delete message may be reused to implicitly indicate the SMF to suspend the NASsmf entity.

### Example 3

The first NF is an LMF. The AMF may send a message #E3 to the LMF, and suspend a NASlmf entity based on the message #E3.

For example, the message #E3 may explicitly indicate the LMF to suspend the NASlmf entity. For example, the message #E3 may include 1 bit. When a value of the bit is “1”, the message #E3 indicates the LMF to suspend the NASlmf entity.

Alternatively, the message #E3 may implicitly indicate the LMF to suspend the NASlmf entity (for example, the message #E3 is a location service delete message). In other words, the location service delete message may be reused to implicitly indicate the LMF to suspend the NASlmf entity.

S502: the terminal device suspends a NAS entity corresponding to the first NF, and stores the security context of the first NF.

The security context of the first NF includes one or more of the type of the first NF, the identifier of the first NF, the NAS count of the first NF, the identifier of the security algorithm selected by the first NF, the PDU session identifier, and the identifier of the terminal device.

For example, the security context of the first NF includes the type of the first NF and/or the identifier of the first NF, the NAS count of the first NF, and the identifier of the security algorithm selected by the first NF. Optionally, the security context of the first NF may further include one or more of the PDU session identifier and the identifier of the terminal device.

In this embodiment, the terminal device may maintain a plurality of NAS counts. For example, the terminal device may maintain the NAS count of the SMF at a granularity of a PDU session. The terminal device may maintain the NAS count of the AMF. The terminal device may maintain the NAS count of the LMF. The terminal device may maintain the NAS count of the PCF.

The following describes a trigger condition of S502.

### Case 1

When the terminal device enters an idle state or an inactive state, the terminal device suspends a NAS entity corresponding to the first NF, and stores the security context of the first NF.

For example, when the terminal device enters the idle state or the inactive state, the terminal device suspends the NASamf entity and/or the NASpcf entity.

### Case 2

The terminal device receives a message #F, and suspends the NAS entity corresponding to the first NF based on the message #F.

For example, the message #F may be an RRC release message or a NAS de-registration message. After receiving the message #F, the terminal device suspends the NASamf entity and/or the NASpcf entity.

For example, the message #F may be a PDU session release message. After receiving the message #F, the terminal device suspends the NASsmf entity.

For example, the message #F may be a location service release message. After receiving the message #F, the terminal device suspends the NASlmf entity.

It may be understood that, if the first NF and the terminal device store the security context when suspending the NAS entity, the first NF and the terminal device may not obtain the security context from another network element when subsequently resuming the NAS entity. In this way, signaling interaction is reduced, and efficiency of resuming the NAS entity is improved.

The embodiments further provide a NAS entity delete mechanism in a NAS security mechanism. FIG. 6 shows a method 600 provided in the embodiments. It may be understood that, in an embodiment, the method 600 may be performed based on the method 400, or the method 400 and the method 500. For example, the method 600 includes the following steps or operations.

S601: the first NF deletes a NAS entity, and deletes a security context of the first NF.

In an embodiment, the first NF may receive a message #G, delete a NAS entity corresponding to the first NF based on the message #G, and delete the security context of the first NF.

### Example 1

The first NF is a PCF. The AMF may send a message #G1 to the PCF. The message #G1 indicates the PCF to delete a NASpcf entity.

For example, the message #G1 may explicitly indicate the PCF to delete the NASpcf entity. For example, the message #G1 may include 1 bit. When a value of the bit is “1”, the message #G1 indicates the PCF to delete the NASpcf entity.

Alternatively, the message #G1 may implicitly indicate the PCF to delete the NASpcf entity. For example, a message may be reused, and a message type of the message implicitly indicate the PCF to delete the NASpcf entity.

### Example 2

The first NF is an SMF. The AMF may send a message #G2 to the SMF. The message #G2 indicates the SMF to delete a NASsmf entity.

For example, the message #G2 may explicitly indicate the SMF to delete the NASsmf entity. For example, the message #G2 may include 1 bit. When a value of the bit is “1”, the message #G2 indicates the SMF to delete the NASsmf entity.

Alternatively, the message #G2 may implicitly indicate the SMF to delete the NASsmf entity (for example, the message #G2 is a PDU session delete message). In other words, the PDU session delete message may be reused to implicitly indicate the SMF to delete the NASsmf entity.

### Example 3

The first NF is an LMF. The LMF may receive a message #G3, and delete a NASlmf entity based on the message #G3.

For example, the message #G3 may explicitly indicate the LMF to delete the NASlmf entity. For example, the message #G3 may include 1 bit. When a value of the bit is “1”, the message #G3 indicates the LMF to delete the NASlmf entity.

Alternatively, the message #G3 may implicitly indicate the LMF to delete the NASlmf entity (for example, the message #G3 is a location service delete message). In other words, the location service delete message may be reused to implicitly indicate the LMF to delete the NASlmf entity.

S602: the terminal device deletes a NAS entity corresponding to the first NF, and deletes the security context of the first NF.

The following describes a trigger condition of S602.

### Case 1

When the terminal device enters an idle state or an inactive state, the terminal device deletes the NAS entity corresponding to the first NF, and deletes the security context of the first NF.

For example, when the terminal device enters the idle state or the inactive state, the terminal device deletes a NASamf entity and/or a NASpcf entity.

### Case 2

The terminal device receives a message #H, and deletes the NAS entity corresponding to the first NF based on the message #H.

Similarly, the message #H may explicitly or implicitly indicate the terminal device to delete the NAS entity corresponding to the first NF.

For example, the message #H may be an RRC release message or a NAS de-registration message. After receiving the message #H, the terminal device deletes a NASamf entity and/or a NASpcf entity.

For example, the message #H may be a PDU session release message. After receiving the message #H, the terminal device deletes a NASsmf entity.

For example, the message #H may be a location service release message. After receiving the message #H, the terminal device deletes a NASlmf entity.

It may be understood that the security context is deleted when the NAS entity is deleted, to reduce storage space of the terminal device and storage space of the first NF.

The embodiments further provide a NAS key deactivate mechanism in a NAS security mechanism. For example, FIG. 7 shows a method 700 provided in the embodiments. It may be understood that, in an embodiment, the method 700 may be performed based on the method 400. For example, the method 700 includes the following steps or operations.

S701: a first NF deactivates a first NAS key.

The following describes a trigger condition of S701.

### Case 1

The first NF deactivates the first NAS key when suspending or deleting a NAS entity corresponding to the first NF.

### Case 2

The first NF receives a message #I (such as, a sixth message), and deactivates the first NAS key based on the message #I.

Similarly, the message #I may explicitly or implicitly indicate the first NF to deactivate the first NAS key.

For example, the first NF is an AMF, a radio access network device may send a UE context release request message (an example of the message #I) to the AMF, and the AMF may deactivate, based on the message, a NAS key related the AMF. Alternatively, after sending a UE context release command to a radio access network device, the AMF may deactivate a NAS key related to the AMF.

For example, the first NF is an SMF, a radio access network device may send a UE context release request message to the SMF, and the SMF may deactivate, based on the message, a NAS key related the SMF. Alternatively, after sending a UE context release command to a radio access network device, the SMF may deactivate a NAS key related to the SMF.

S702: the terminal device deactivates a first NAS key generated for the first NF.

The following describes a trigger condition of S702.

### Case 1

The terminal device deactivates the first NAS key when suspending or deleting the NAS entity corresponding to the first NF.

### Case 2

The terminal device receives a message #J (such as, a second message), and deactivates the first NAS key based on the message #J.

Similarly, the message #J may explicitly or implicitly indicate the terminal device to deactivate the first NAS key.

For example, the terminal device may deactivate the first NAS key after receiving an access network connection release (AN connection release) message (an example of the message #J) sent by the radio access network device.

For another example, the terminal device may deactivate the first NAS key after sending an AN connection release message to the radio access network device.

Optionally, the terminal device may send deactivation success information after the terminal device successfully deactivates the first NAS key. Correspondingly, the first NF receives the deactivation success information from the terminal device. The deactivation success information indicates that the terminal device successfully deactivates the first NAS key.

For example, the terminal device may send the deactivation success information to the first NF through the radio access network device.

Alternatively, the terminal device may send the deactivation success information to the first NF through the radio access network device and an anchor function (for example, an AMF). It may be understood that, in this case, the first NF is not an anchor function.

Optionally, the embodiments further provide a NAS security mechanism used when a terminal device transitions from an idle state (idle) or an inactive state (inactive) to a connected state (connected).

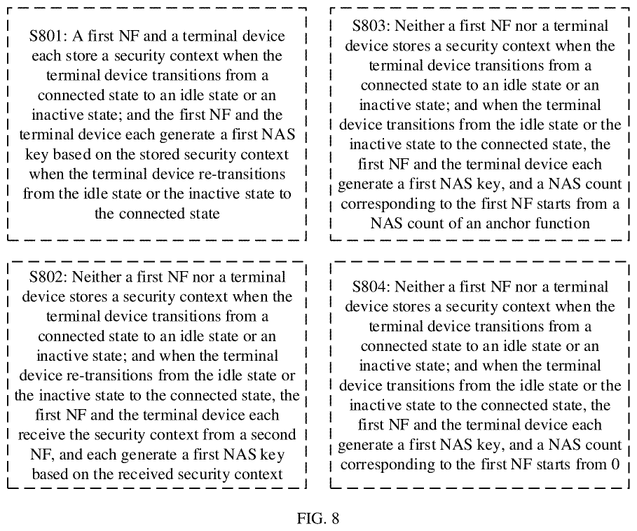

FIG. 8 shows a method 800 provided in the embodiments. It may be understood that, in an embodiment, the method 800 may be performed based on the method 400. For example, the method 800 includes four parallel cases: S801, S802, S803, and S804.

S801: a first NF and a terminal device each store a security context when the terminal device transitions from a connected state to an idle state or an inactive state; and the first NF and the terminal device each generate a first NAS key based on the stored security context when the terminal device re-transitions from the idle state or the inactive state to the connected state.

As described above, it may be understood that a first NAS key generated by the first NF may be the same as or different from a first NAS key generated by the terminal device for the first NF. Details are not described again.

The security context includes one or more of a type of the first NF, an identifier of the first NF, an identifier of the terminal device, an identifier of a security algorithm selected by the first NF, a NAS count of the first NF, and a PDU session identifier.

For example, a security context stored by the terminal device includes the type of the first NF and/or the identifier of the first NF, the identifier of the security algorithm selected by the first NF, and the NAS count of the first NF. Optionally, the security context further includes one or more of the PDU session identifier and the identifier of the terminal device.

For another example, a security context stored by the first NF includes the identifier of the terminal device, the identifier of the security algorithm selected by the first NF, and the NAS count of the first NF. Optionally, the security context further includes one or more of the PDU session identifier, the type of the first NF, and the identifier of the first NF.

It may be understood that when the terminal device transitions from the connected state to the idle state or the inactive state, the first NF and the terminal device each store the security context. When the terminal device re-transitions from the idle state or the inactive state to the connected state subsequently, the first NF and the terminal device may not obtain the security context from another network element. In this way, signaling interaction is reduced.

In addition, when the terminal device transitions from the connected state to the idle state or the inactive state, the first NF may suspend a NAS entity, and the terminal device also suspends a NAS entity. When the terminal device transitions from the idle state or the inactive state to the connected state, the first NF reactivates (or resumes) the NAS entity, and the terminal device also reactivates the NAS entity.

S802: neither first NF nor a terminal device stores a security context when the terminal device transitions from a connected state to an idle state or an inactive state; and when the terminal device re-transitions from the idle state or the inactive state to the connected state, the first NF and the terminal device each receive the security context from a second NF, and each generate a first NAS key based on the received security context.

As described above, it may be understood that a first NAS key generated by the first NF may be the same as or different from a first NAS key generated by the terminal device for the first NF. Details are not described again.

The second NF is configured to store the security context. For example, the second NF may be an AMF. In another embodiment, the second NF may be another NF. The security context includes one or more of an identifier of the terminal device, a type of the first NF, an identifier of the first NF, an identifier of a security algorithm selected by the first NF, a NAS count of the first NF, and a PDU session identifier.

For example, the security context includes the identifier of the terminal device, the type of the first NF and/or the identifier of the first NF, the identifier of the security algorithm selected by the first NF, and the NAS count of the first NF. Optionally, the security context further includes the PDU session identifier.

In other words, in an embodiment, when the terminal device transitions from the connected state to the idle state or the inactive state, the second NF may replace the first NF and the terminal device to store the security context, thereby saving storage space of the first NF and storage space of the terminal device. For example, the first NF may send the security context to the second NF, and/or the terminal device may send the security context to the second NF.

In addition, in S802, the terminal device and the first NF do not store the security context. When the terminal device transitions from the connected state to the idle state or the inactive state, the first NF may delete a NAS entity, and the terminal device also deletes a NAS entity. When the terminal device transitions from the idle state or the inactive state to the connected state, the first NF re-establishes a NAS entity, and the terminal device also re-establishes a NAS entity.

Optionally, in a case, if the terminal device or the first NF initiates a deregistration procedure of the terminal device, the terminal device and the first NF each may delete a corresponding NAS entity.

S803: neither a first NF nor a terminal device stores a NAS count of the first NF when the terminal device transitions from a connected state to an idle state or an inactive state; and when the terminal device transitions from the idle state or the inactive state to the connected state, the first NF and the terminal device each generate a first NAS key, and the NAS count corresponding to the first NF starts from a NAS count of an anchor function (for example, an AMF).

As described above, it may be understood that a first NAS key generated by the first NF may be the same as or different from a first NAS key generated by the terminal device for the first NF. Details are not described again.

It may be understood that, in S803, the first NF is not an anchor function. In other words, the first NF is a non-anchor function.

In S803, the first NF and the terminal device do not store the NAS count of the first NF, but may store other information in security context, for example, may store one or more of a type of the first NF, an identifier of the first NF, an identifier of a security algorithm selected by the first NF, a PDU session identifier, and an identifier of the terminal device.

In other words, in S803, when the terminal device transitions from the connected state to the idle state or the inactive state, the terminal device and the first NF do not store the NAS count of the first NF. When the terminal device transitions from the idle state or the inactive state to the connected state, the first NF and the terminal device each obtain the NAS count of the anchor function from the anchor function. Because a NAS count of an AMF is random, a security level of a subsequently generated first NAS key can be improved.

S804: neither a first NF nor a terminal device stores a NAS count of the first NF when the terminal device transitions from a connected state to an idle state or an inactive state; and when the terminal device transitions from the idle state or the inactive state to the connected state, the first NF and the terminal device each generate a first NAS key, and a NAS count corresponding to the first NF starts from 0.

As described above, it may be understood that a first NAS key generated by the first NF may be the same as or different from a first NAS key generated by the terminal device for the first NF. Details are not described again.

It may be understood that, similar to S803, in S804, the first NF and the terminal device do not store the NAS count of the first NF, but may store other information in security context, for example, may store one or more of a type of the first NF, an identifier of the first NF, an identifier of a security algorithm selected by the first NF, a PDU session identifier, and an identifier of the terminal device.

In other words, in S804, when the terminal device transitions from the connected state to the idle state or the inactive state, the terminal device and the first NF do not store the NAS count of the first NF, and do not maintain a NAS count of an anchor function (for example, an AMF), thereby simplifying a NAS security mechanism of the terminal device and the first NF.

It can be understood from the foregoing descriptions that in a future communication system, each of a plurality of NFs directly connected to a radio access network device has a corresponding NAS key. In some cases, a NAS key of a terminal device and a NAS key of the NF may be synchronously updated (rekeying). Therefore, optionally, the embodiments further provide a NAS key update mechanism in a NAS security mechanism. The following describes the NAS key update mechanism in two cases.

### Case 1

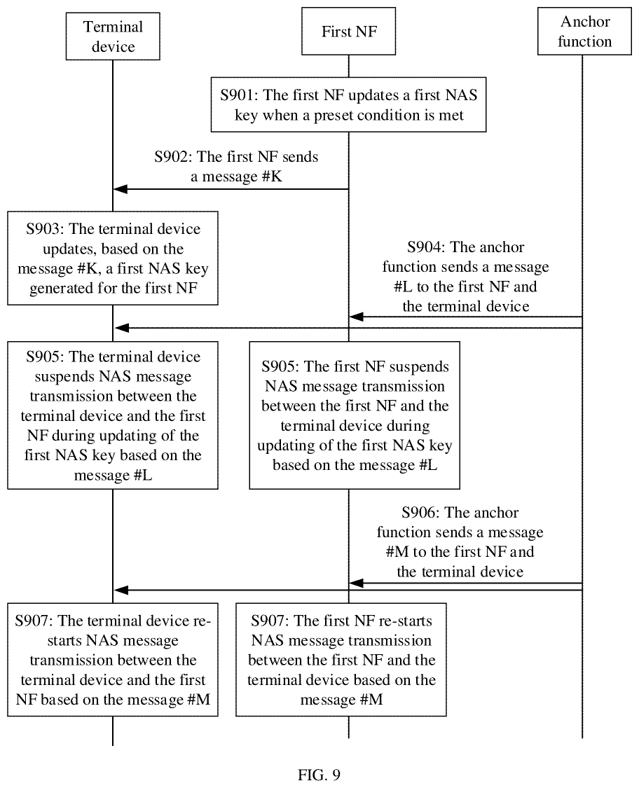

When a NAS key is generated, K_{SEAF} is a root key. When a NAS key of a first NF in a plurality of NFs directly connected to a radio access network device is updated, the first NF may perform an independent NAS key update procedure on a terminal device. FIG. 9 shows a method 900 provided in the embodiments. It may be understood that, in an embodiment, the method 900 may be performed based on the method 400. The method 900 includes the following steps or operations.

S901: the first NF updates a first NAS key when a preset condition is met.

For example, the preset condition may be that a value of a NAS count corresponding to the first NF reaches a maximum value.

S902: the first NF sends a message #K (such as, a third message). Correspondingly, the terminal device receives the message #K from the first NF.

The message #K indicates the terminal device to update the first NAS key. For example, the message #K may be a NAS message.

Optionally, in a manner, the first NF may send a NAS message to the radio access network device. The NAS message includes information for indicating the terminal device to update the first NAS key, and the radio access network device sends the NAS message to the terminal device. For example, the NAS message is transparently transmitted by the radio access network device.

S903: the terminal device updates, based on the message #K, a first NAS key generated for the first NF.

For example, the first NF is an SMF, and the terminal device may update KSMF, KNASsmf-enc, and KNASsmf-int based on the message #K.

In another embodiment, the first NF may alternatively be a PCF, an LMF, an AMF, or the like.

It may be understood that S901 to S903 are synchronous NAS key update triggered by the first NF. In another manner, the terminal device may trigger the synchronous NAS key update. For example, when the preset condition is met, the terminal device may update the first NAS key, and the terminal device may send indication information to the first NF, to indicate the first NF to update the NAS key. The first NF may update the NAS key based on the indication information of the terminal device.

For example, the terminal device may directly send the indication information to the first NF.

Alternatively, the terminal device may send the indication information to an anchor function (for example, an AMF). Further, the anchor function may indicate the first NF to update the NAS key. In this case, the first NF is not an anchor function. In other words, the first NF is a non-anchor function.

It may be understood that when the value of the NAS count reaches the maximum value, the first NF and the terminal device synchronously update the NAS key, to avoid attack replay of a third party, thereby improving security.

Optionally, if the first NF is not an anchor function. In other words, the first NF is a non-anchor function. The method 900 further includes S904 to S907.

S904: the anchor function sends a message #L to the first NF and the terminal device. Correspondingly, the first NF and the terminal device receive the message #L.

The message #L indicates to suspend NAS message transmission between the first NF and the terminal device during updating of the first NAS key.

It may be understood that an execution sequence of S904 and S901 is not limited by the description herein. In a case, S904 may alternatively be performed before S901.

S905: the first NF and the terminal device suspend NAS message transmission during updating of the first NAS key based on the message #L.

It may be understood that, during updating of the NAS key, an old NAS key may be invalid, but a new NAS key is not successfully enabled. Therefore, during updating of the NAS key, the first NF and the terminal device may suspend NAS message transmission, to reduce a probability of a NAS message parsing error.

S906: the anchor function sends a message #M to the first NF and the terminal device. Correspondingly, the first NF and the terminal device receive the message #M.

The message #M indicates to resume NAS message transmission between the first NF and the terminal device.

In an embodiment, after the anchor function sends the message #L, the anchor function may start a timer. For example, preset duration of the timer is greater than or equal to duration required for updating the NAS key. After the timer expires, the anchor function sends the message #M.

In another embodiment, after successfully updating the first NAS key, the first NF may notify the anchor function that the first NF successfully updates the first NAS key. Similarly, after successfully updating the first NAS key, the terminal device may notify the anchor function that the terminal device successfully updates the first NAS key. On this basis, the anchor function may send the message #M.

S907: the first NF and the terminal device re-start NAS message transmission based on the message #M.

Similar to S904 to S907, optionally, if the first NF is an anchor function, the first NF may send the message #L to the terminal device, to indicate the terminal device to suspend NAS message transmission between the terminal device and the first NF during updating of the first NAS key. Alternatively, the first NF may suspend NAS message transmission between the first NF and the terminal device during updating of the first NAS key. Subsequently, the first NF may send the message #M to the terminal device, to indicate the terminal device to resume NAS message transmission between the terminal device and the first NF. Correspondingly, the first NF may also resume NAS message transmission between the first NF and the terminal device.

### Case 2

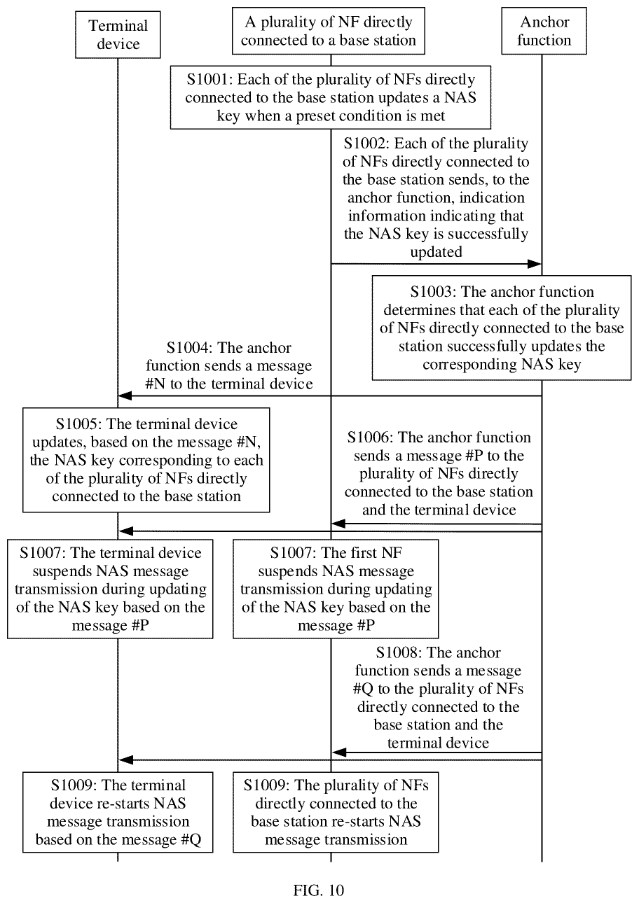

When a NAS key is generated, K_{AMF} is a root key. If K_{AMF} is updated, a NAS key of each of a plurality of NFs directly connected to a radio access network device may be updated. Correspondingly, a terminal device also may update the NAS key corresponding to each of the plurality of NFs. FIG. 10 shows a method 1000 provided in the embodiments. It may be understood that, in an embodiment, the method 1000 may be performed based on the method 400. The method 1000 includes the following steps or operations.

S1001: each of the plurality of NFs directly connected to the radio access network device updates the NAS key when a preset condition is met.

For example, a NAS count of one (for example, a first NF) of the plurality of NFs directly connected to the radio access network device reaches a maximum value. If the first NF is not an anchor function, the first NF may send a NAS key update request message to the anchor function. Further, the anchor function may send the NAS key update request message to an NF other than the first NF and the anchor function in the plurality of NFs, so that each of the plurality of NFs directly connected to the radio access network device updates the NAS key. If the first NF is an anchor function, the first NF may send a NAS key update request message to an NF other than the first NF in the plurality of NFs, so that each of the plurality of NFs directly connected to the radio access network device updates the NAS key.

S1002: the plurality of NFs directly connected to the radio access network device send, to an anchor function, indication information indicating that the NAS key is successfully updated. Correspondingly, the anchor function receives, from the plurality of NFs, the indication information indicating that the NAS key is successfully updated.

It may be understood that S1002 is an optional step or operation. In another manner, the anchor function may consider, by default, that each of the plurality of NFs directly connected to the radio access network device successfully updates the corresponding NAS key.

S1003: the anchor function determines that each of the plurality of NFs directly connected to the radio access network device successfully updates the NAS key.

For example, the plurality of NFs directly connected to the radio access network device include an AMF, an SMF, a PCF, and an LMF, and the anchor function is an AMF. The AMF may determine that the AMF, the SMF, the PCF, and the LMF each successfully update a corresponding NAS key.

S1004: the anchor function sends a message #N (such as, a fourth message) to the terminal device. Correspondingly, the terminal device receives the message #N from the anchor function.

The message #N indicates the terminal device to update the NAS key corresponding to each of the plurality of NFs directly connected to the radio access network device. For example, the message #N may be a NAS message.

Optionally, in a manner, the anchor function may send a NAS message to the radio access network device. The NAS message includes information for indicating the terminal device to update the NAS key corresponding to each of the plurality of NFs, and the radio access network device sends the NAS message to the terminal device. For example, the NAS message is transparently transmitted by the radio access network device.

S1005: the terminal device updates, based on the message #N, the NAS key corresponding to each of the plurality of NFs directly connected to the radio access network device.

For example, the plurality of NFs directly connected to the radio access network device include an AMF, an SMF, a PCF, and an LMF. The terminal device may update a NAS key corresponding to the AMF, a NAS key corresponding to the SMF, a NAS key corresponding to the PCF, and a NAS key corresponding to the LMF based on the message #N.

It may be understood that in S1001 to S1005, a network side initiates joint updating of the NAS key. In another case, the terminal device may alternatively initiate joint updating of the NAS key. For example, if a NAS count of one of a plurality of NFs directly connected to the radio access network device reaches a maximum value, the terminal device updates the NAS key corresponding to each of the plurality of NFs. Further, the terminal device sends indication information to the plurality of NFs, so that each of the plurality of NFs updates the corresponding NAS key. For example, the terminal device may directly send the indication information to the plurality of NFs. Alternatively, the terminal device may send the indication information to the anchor function. Further, the anchor function may indicate a CN NF other than the anchor function in the plurality of NFs to update the NAS key.

It may be understood that when a value of the NAS count reaches the maximum value, the plurality of NFs directly connected to the radio access network device and the terminal device synchronously update the NAS key, to avoid attack replay of a third party, thereby improving security.

Optionally, the method 1000 further includes S1006 to S1009.

S1006: the anchor function sends a message #P to the plurality of NFs directly connected to the radio access network device and the terminal device. Correspondingly, the first NF and the terminal device receive the message #P.

The message #P indicates to suspend NAS message transmission during updating of the NAS key.

S1007: the plurality of NFs directly connected to the radio access network device and the terminal device suspend NAS message transmission during updating of the NAS key based on the message #P.

It may be understood that, during updating of the NAS key, an old NAS key may be invalid, but a new NAS key is not successfully enabled. Therefore, during updating of the NAS key, the plurality of NFs directly connected to the radio access network device and the terminal device may suspend NAS message transmission, to reduce a probability of a NAS message parsing error.

S1008: the anchor function sends a message #Q to the plurality of NFs directly connected to the radio access network device and the terminal device. Correspondingly, the first NF and the terminal device receive the message #Q.

The message #Q indicates to resume NAS message transmission.

For a trigger mechanism of the message #Q, refer to S906.

S1009: the plurality of NFs directly connected to the radio access network device and the terminal device re-start NAS message transmission based on the message #Q.

Optionally, in some cases, an NF that provides a service for the terminal device changes. For example, a source NF changes to a target NF. Therefore, the embodiments further provide a NAS security mechanism used when a terminal device is handed over (handover). FIG. 11 shows a method 1100 provided in the embodiments. It may be understood that, in an embodiment, the method 1100 may be performed based on the method 400. The method 1100 includes the following steps or operations.

S1101: a first NF sends a security context of the terminal device. Correspondingly, a first target NF receives the security context of the terminal device.

The security context includes a NAS count maintained by the first NF. Optionally, the security context further includes one or more of a PDU session identifier and security capability information of the terminal device.

The following describes a manner in which the first target NF receives the security context.

### Manner 1

The first NF sends the security context to an anchor function. Further, the anchor function sends the security context to the first target NF.

It may be understood that, in Manner 1, the first NF is not an anchor function. In other words, the first NF is a non-anchor function.

For example, the first NF is a source SMF, the anchor function is an AMF, the first target NF is a target SMF, and the source SMF may send the security context to the target SMF through the AMF.

For another example, the first NF is a source PCF, the anchor function is an AMF, the first target NF is a target PCF, and the source PCF may send the security context to the target PCF through the AMF.

For another example, the first NF is a source LMF, the anchor function is an AMF, the first target NF is a target LMF, and the source LMF may send the security context to the target LMF through the AMF.

It may be understood that if the anchor function is also handed over, for example, is handed over from a source anchor function to a target anchor function, the first NF may send the security context to the first target NF through the source anchor function (for example, a source AMF) and the target anchor function (for example, a target AMF).

### Manner 2

The first NF directly sends the security context to the first target NF.

For example, the first NF is a source SMF, the first target NF is a target SMF, and the source SMF may directly send the security context to the target SMF.

For another example, the first NF is a source PCF, the first target NF is a target PCF, and the source PCF may directly send the security context to the target PCF.

For another example, the first NF is a source LMF, the first target NF is a target LMF, and the source LMF may directly send the security context to the target LMF.

For another example, the first NF is a source AMF, the first target NF is a target AMF, and the source AMF may directly send the security context to the target AMF.

### Manner 3

For example, an anchor function is an AMF. The AMF may also send, to the first target NF, security capability information that is of the terminal device and that is maintained by the AMF.

For example, if the first target NF is a target SMF, the AMF may send the security capability information of the terminal device to the target SMF. For another example, if the first target NF is a target PCF, the AMF may send the security capability information of the terminal device to the target PCF. For another example, if the first target NF is a target LMF, the AMF may send the security capability information of the terminal device to the target LMF.

It may be understood that if the anchor function is also handed over, for example, is handed over from a source anchor function to a target anchor function, the source anchor function (for example, a source AMF) may send the security capability information of the terminal device to the first target NF through the target anchor function (for example, a target AMF).

S1102: the first target NF generates a NAS key based on the security context of the terminal device.

It may be understood that the first target NF may select a security algorithm based on the security capability information of the terminal device, and generate the NAS key.

In addition, the first target NF may send, to the terminal device, information about the security algorithm selected by the first target NF. For example, the first target NF may send the information about the security algorithm to the terminal device in the following several manners.

### Manner 1

The first target NF directly sends the information about the security algorithm to the terminal device.

For example, the first target NF sends a NAS message to the terminal device. The NAS message includes the information about the security algorithm.

### Manner 2

The first target NF may send the information about the security algorithm to the terminal device through the anchor function (for example, an AMF).

It may be understood that, in Manner 2, the first target NF is not an anchor function. In other words, the first target NF is a non-anchor function.

For example, the first target NF is a target SMF, and the target SMF may send, to the terminal device through the AMF, an identifier of the security algorithm selected by the target SMF.

For example, the first target NF is a target LMF, and the target LMF may send, to the terminal device through the AMF, an identifier of the security algorithm selected by the target LMF.

For example, the first target NF is a target PCF, and the target PCF may send, to the terminal device through the AMF, an identifier of the security algorithm selected by the target PCF.

It may be understood that if the anchor function is also handed over, for example, is handed over from a source anchor function to a target anchor function, the first target NF may send the information about the security algorithm to the terminal device through the target anchor function (for example, a target AMF) and the source anchor function (for example, a source AMF).

### Manner 3

The first target NF may send the information about the security algorithm to the terminal device through the first NF.

For example, the first target SMF may send the information about the security algorithm to the terminal device through the first SMF.

### Manner 4

The first target NF may send the information about the security algorithm to the terminal device through the anchor function and the first NF.

It may be understood that in Manner 4, the first target NF and the first NF are not anchor functions. In other words, the first target NF and the first NF are non-anchor functions.

For example, the first target SMF may send the information about the security algorithm to the terminal device through the AMF and the first SMF.

According to this embodiment, the terminal device may be handed over from the source SMF to the target SMF, from the source LMF to the target LMF, from the source AMF to the target AMF, or from the source PCF to the target PCF. The source NF may send the security context of the terminal device to the target NF, to reduce signaling overheads (for example, the terminal device may not send security capability information of the terminal device to the target NF), so that the target NF can generate a NAS key based on the security context of the terminal device, and process a NAS message between the target NF and the terminal device.

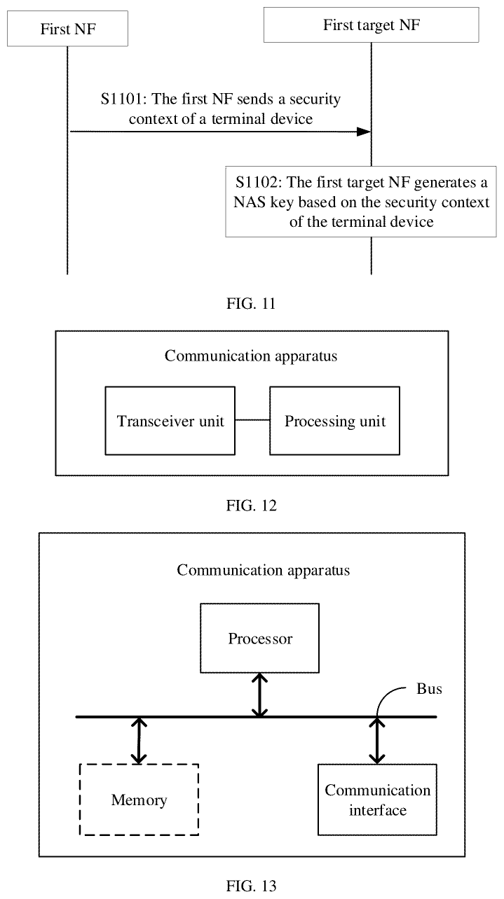

The foregoing describes the method provided in the embodiments. FIG. 12 shows a communication apparatus according to an embodiment. The communication apparatus includes a transceiver unit and a processing unit.

The transceiver unit may be configured to implement a corresponding information receiving and sending function. The transceiver unit may also be referred to as a communication interface or a communication unit. The processing unit may be configured to perform a processing operation.

For example, the apparatus further includes a storage unit. The storage unit may be configured to store instructions and/or data. The processing unit may read the instructions and/or the data in the storage unit, so that the apparatus implements actions of an apparatus in the foregoing method embodiments.

In an embodiment, the apparatus may be the terminal device in the foregoing embodiments, or may be a component (for example, a chip) of the terminal device. The transceiver unit and the processing unit may be configured to implement related operations of the terminal device.

For example, the transceiver unit may be configured to perform S401. The processing unit may be configured to perform S407, S408, S409, and S410.

For another example, the processing unit may be configured to perform S502.

For another example, the processing unit may be configured to perform S602.

For another example, the processing unit may be configured to perform S702.

For another example, the processing unit may be configured to perform any one of S801 to S804.

For another example, the processing unit may be configured to perform S903, S905, and S907.

For another example, the processing unit may be configured to perform S1005, S1007, and S1009.

In another embodiment, the apparatus may be the first NF in the foregoing embodiments, or may be a component (for example, a chip) of the first NF. The transceiver unit and the processing unit may be configured to implement related operations of the first NF.

For example, the transceiver unit may be configured to perform S403. The processing unit may be configured to perform S402, S404, S405, and S406.

For another example, the processing unit may be configured to perform S501.

For another example, the processing unit may be configured to perform S601.

For another example, the processing unit may be configured to perform S701.

For another example, the processing unit may be configured to perform any one of S801 to S804.

For another example, the processing unit may be configured to perform S901, S905, and S907.

For another example, the processing unit may be configured to perform S1001, S1007, and S1009.

It may be understood that a process in which the units perform the foregoing corresponding steps or operations is described in detail in the foregoing method embodiments, and for brevity, details are not described herein again.

The transceiver unit may be replaced with a transceiver (for example, a sending unit in the transceiver unit may be replaced with a transmitter, and a receiving unit in the transceiver unit may be replaced with a receiver), and another unit such as the processing unit may be replaced with a processor, to respectively perform receiving and sending operations and processing-related operations in the foregoing method embodiments.

In addition, the transceiver unit may alternatively be a transceiver circuit (for example, may include a receiving circuit and a sending circuit), and the processing unit may be a processing circuit.

FIG. 13 shows another communication apparatus according to an embodiment. The communication apparatus includes a processor and a communication interface. The processor is configured to execute a program or instructions stored in a memory, or read data stored in the memory, to perform related actions in the foregoing method embodiments. For example, there may be one or more processors. The communication interface is configured to receive and/or send a signal.

For example, the communication apparatus may further include a memory, and the memory is configured to store a computer program or instructions and/or data. The memory may be integrated with the processor, or may be disposed separately. In another embodiment, the communication apparatus may alternatively not include the memory, and the memory may be disposed outside the communication apparatus. For example, there may be one or more memories.

For example, the processor, the communication interface, and the memory are connected to each other through a bus. The bus may be a peripheral component interconnect (PCI) bus, an extended industry standard architecture (EISA) bus, or the like. The bus may be classified into an address bus, a data bus, a control bus, and the like. For ease of representation, only one bold line is used for representation in FIG. 13, but this does not mean that there is only one bus or only one type of bus.

It may be understood that the processor mentioned in embodiments may be a central processing unit (CPU), a network processor (NP), or a combination of a CPU and an NP. The processor may further include a hardware chip. The hardware chip may be an application-specific integrated circuit (ASIC), or a programmable logic device (PLD). The PLD may be a complex programmable logic device (CPLD), a field-programmable gate array (FPGA), generic array logic (GAL), or any combination thereof.

It may be further understood that the memory mentioned in embodiments may be a volatile memory or a nonvolatile memory, or may include both a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache.

It may be understood that, if embodiments are implemented in a form of software and sold or used as an independent product, a corresponding program (which may also be referred to as code or instructions) may be stored in a non-transitory readable storage medium. Therefore, the embodiments further provide a non-transitory readable storage medium, including a program. When the program is run on a device or a computer, the device or the computer is enabled to perform any possible embodiment of the foregoing solutions.

The non-transitory readable storage medium includes any medium that can store program code, such as a USB flash drive, a removable hard disk, a ROM, a RAM, a magnetic disk, an optical disc, or the like.

The solutions of the embodiments may be embodied in a form of a software product. Therefore, the embodiments further provide a program product. The program product includes a program. When the program is run, a device or a computer is enabled to perform any possible embodiment of the foregoing solutions.

In addition, an embodiment further provides a chip system (or a chip). The chip system includes a processor and an interface circuit. The interface circuit is configured to send and/or receive data, instructions, or information for the processor. The processor is configured to perform any possible embodiment of the foregoing solutions.

The foregoing descriptions are merely specific implementations of the embodiments, but are not intended as limiting. Any variation or replacement readily figured out by a person skilled in the art shall fall within the scope of the embodiments.

1. A method, comprising:
generating, by a terminal device, a plurality of non-access stratum (NAS) keys, wherein at least two of the plurality of NAS keys are respectively associated with different network functions (NFs) in a plurality of NFs; and
processing, by the terminal device, a NAS message for communication with the plurality of NFs based on the plurality of NAS keys.

2. The method according to claim 1, wherein generating, by the terminal device, the plurality of NAS keys comprises:
generating, by the terminal device, a first NAS key based on a type parameter of a first NF and/or an identifier of the first NF, an identifier of a security algorithm selected by the first NF, and a NAS count of the first NF, wherein the first NF is one of the plurality of NFs, and the first NAS key is one of the plurality of NAS keys.

3. The method according to claim 1, wherein generating, by the terminal device, the plurality of NAS keys comprises:
generating, by the terminal device, a first NAS key based on a type parameter of a first NF and/or an identifier of the first NF, an identifier of a security algorithm selected by the first NF, a NAS count of the first NF, and a packet data unit (PDU) session identifier, wherein the first NF is one of the plurality of NFs, and the first NAS key is one of the plurality of NAS keys.

4. The method according to claim 1, wherein generating, by the terminal device, the plurality of NAS keys comprises:
generating, by the terminal device, a first NAS key based on an identifier of a security algorithm selected by a first NF, a NAS count of the first NF, and a PDU session identifier, wherein the first NF is one of the plurality of NFs, and the first NAS key is one of the plurality of NAS keys.

5. The method according to claim 2, wherein
the NAS count of the first NF starts from 0; or
the NAS count of the first NF starts from an initial NAS count of an anchor function.

6. The method according to claim 1, wherein generating, by the terminal device, the plurality of NAS keys comprises:
generating, by the terminal device, the plurality of NAS keys based on a NAS root key.

7. The method according to claim 1, further comprising:
activating, by the terminal device, the first NAS key when creating a NAS entity corresponding to the first NF; or
receiving, by the terminal device, a first message, and activating the first NAS key based on the first message, wherein
the first NF is one of the plurality of NFs, and the first NAS key is one of the plurality of NAS keys.

8. The method according to claim 1, further comprising:
deactivating, by the terminal device, the first NAS key when suspending or deleting the NAS entity corresponding to the first NF; or
receiving, by the terminal device, a second message, and deactivating the first NAS key based on the second message, wherein
the first NF is one of the plurality of NFs, and the first NAS key is one of the plurality of NAS keys.

9. The method according to claim 1, further comprising:
storing, by the terminal device, a security context of the first NF when transitioning from a connected state to an idle state or an inactive state, wherein the security context of the first NF comprises the identifier of the security algorithm selected by the first NF and the NAS count of the first NF; and
generating, by the terminal device, the first NAS key based on the security context of the first NF when transitioning from the idle state or the inactive state to the connected state, wherein
the first NF is one of the plurality of NFs, and the first NAS key is one of the plurality of NAS keys.

10. The method according to claim 1, further comprising:
skipping storing, by the terminal device, a security context of the first NF when transitioning from a connected state to an idle state or an inactive state; and
when transitioning from the idle state or the inactive state to the connected state, obtaining, by the terminal device, the security context of the first NF from a second NF, and generating the first NAS key based on the security context of the first NF, wherein
the first NF is one of the plurality of NFs, and the first NAS key is one of the plurality of NAS keys.

11. The method according to claim 1, further comprising:
skipping storing, by the terminal device, the NAS count of the first NF when transitioning from a connected state to an idle state or an inactive state; and
generating, by the terminal device, the first NAS key when transitioning from the idle state or the inactive state to the connected state, wherein
the NAS count corresponding to the first NF starts from 0, or the NAS count corresponding to the first NF starts from the initial NAS count of the anchor function; and
the first NF is one of the plurality of NFs, and the first NAS key is one of the plurality of NAS keys.

12. The method according to claim 1, further comprising:
receiving, by the terminal device, a third message from the first NF, and updating the first NAS key based on the third message, wherein the first NF is one of the plurality of NFs, and the first NAS key is one of the plurality of NAS keys; or
receiving, by the terminal device, a fourth message from the anchor function, and updating the plurality of NAS keys based on the fourth message.

13. A communication apparatus, comprising a processor, wherein the processor is configured to, when executing programming instructions, enable the communication apparatus to:
generate, by a terminal device, a plurality of non-access stratum (NAS) keys, wherein at least two of the plurality of NAS keys are respectively associated with different network functions (NFs) in a plurality of NFs; and
process, by the terminal device, a NAS message for communication with the plurality of NFs based on the plurality of NAS keys.

14. The apparatus according to claim 13, wherein generating, by the terminal device, the plurality of NAS keys comprises:
generating, by the terminal device, a first NAS key based on a type parameter of a first NF and/or an identifier of the first NF, an identifier of a security algorithm selected by the first NF, and a NAS count of the first NF, wherein the first NF is one of the plurality of NFs, and the first NAS key is one of the plurality of NAS keys.

15. The apparatus according to claim 13, wherein generating, by the terminal device, the plurality of NAS keys comprises:
generating, by the terminal device, a first NAS key based on a type parameter of a first NF and/or an identifier of the first NF, an identifier of a security algorithm selected by the first NF, a NAS count of the first NF, and a PDU session identifier, wherein the first NF is one of the plurality of NFs, and the first NAS key is one of the plurality of NAS keys.

16. The apparatus according to claim 13, wherein generating, by the terminal device, the plurality of NAS keys comprises:
generating, by the terminal device, a first NAS key based on an identifier of a security algorithm selected by a first NF, a NAS count of the first NF, and a PDU session identifier, wherein the first NF is one of the plurality of NFs, and the first NAS key is one of the plurality of NAS keys.

17. The apparatus according to claim 14, wherein
the NAS count of the first NF starts from 0; or
the NAS count of the first NF starts from an initial NAS count of an anchor function.

18. The apparatus according to claim 13, wherein generating, by the terminal device, the plurality of NAS keys comprises:
generating, by the terminal device, the plurality of NAS keys based on a NAS root key.

19. The apparatus according to claim 13, wherein the processor further enables the apparatus to:
activate, by the terminal device, the first NAS key when creating a NAS entity corresponding to the first NF; or
receive, by the terminal device, a first message, and activate the first NAS key based on the first message, wherein
the first NF is one of the plurality of NFs, and the first NAS key is one of the plurality of NAS keys.

20. A non-transitory computer-readable storage medium, comprising a computer program or instructions, wherein when the computer program or the instructions are run on a computer, the computer is enabled to perform-: generating, by a terminal device, a plurality of non-access stratum (NAS) keys, wherein at least two of the plurality of NAS keys are respectively associated with different network functions (NFs) in a plurality of NFs; and
processing, by the terminal device, a NAS message for communication with the plurality of NFs based on the plurality of NAS keys.
